(19) United States
(12) Patent Application Publication
(10) Pub. No.: US 2024/0257054 A1
(43) Pub. Date: Aug. 1, 2024

(54) IDENTIFICATION OF PATENT-RELEVANT MESSAGES IN A GROUP-BASED COMMUNICATION SYSTEM USING MACHINE LEARNING TECHNIQUES

(71) Applicant: Salesforce, Inc., San Francisco, CA (US)

(72) Inventors: Aaron Maurer, Washington, DC (US); Serguei Mourachov, Vancouver (CA); Fiona Condon, Brooklyn, NY (US); Katrina Ni, Vancouver (CA)

(21) Appl. No.: 18/103,342

(22) Filed: Jan. 30, 2023

(51) Int. Cl. G06Q 10/101; G06F 16/34; G06F 16/35; G06Q 50/18

(52) U.S. Cl. CPC G06Q 10/101; G06F 16/345; G06F 16/353; G06Q 50/184

(57) ABSTRACT

Methods, systems, apparatuses, devices, and computer program products are described. In a group-based communication system, users may post messages discussing potentially patentable concepts. To support automatic identification of patent-relevant messages within the group-based communication system, the system may use a machine learning model including at least an embedding function. The system may generate a set of features for one or more messages and may input the set of features into the machine learning model. Using the embedding function, the model may create a message embedding and may compare the message embedding with embeddings of patent application language to determine a level of similarity. The machine learning model may output an indication of whether the one or more messages are associated with a patentable concept based on the embedding, and the indication may be surfaced to a user associated with managing patents for an organization of the group-based communication system.

### TECHNICAL FIELD

The present disclosure relates generally to communication systems and data processing, and more specifically to identification of patent-relevant messages in a group-based communication system using machine learning techniques.

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

Users may communicate information using a communication platform (e.g., a group-based communication system, separate from or associated with the cloud platform). In some examples, the group-based communication system may support different groups of users sharing content within specific channels. Users may post messages discussing technical ideas (e.g., products, manufacturing processes, inventions) to channels of the group-based communication platform. Some of these ideas could potentially support patent application filings, which could provide significant value to the users' organization. However, the users may lack the technical or legal expertise to identify if a technical idea could support a patent application filing. Additionally, posts discussing potential patentable ideas may be spread across multiple channels, hidden based on visibility or privacy settings, or both. Accordingly, an organization using the group-based communication platform may fail to identify valuable patent ideas being discussed by members of their organization.

### SUMMARY

The described techniques relate to improved methods, systems, devices, and apparatuses that support identification of patent-relevant messages in a group-based communication system using machine learning techniques. In some group-based communication systems, users may post messages discussing potentially patentable concepts. To support automatic identification of patent-relevant messages within a group-based communication system, the system may use a machine learning model including at least an embedding function. The embedding function may create an embedding space including embeddings of patent applications (e.g., portions of patent application documents). If a patent-relevancy test is triggered for one or more messages within the group-based communication system, the system may generate a set of features for the one or more messages and may input the set of features into the machine learning model. Using the embedding function, the model may create a message embedding and may compare the message embedding with patent application embeddings to determine a level of similarity. Based on the embeddings, one or more additional features for the messages, or both, the machine learning model may output an indication of whether the one or more messages are associated with a patentable concept. If the output indicates that the messages are associated with a patentable concept, the system may surface, to a user device, an indication that the messages are predicted to be associated with a patentable concept. The user device may be operated by a user (e.g., a patent professional) who manages patent work for an organization. The user may review the messages to either confirm or deny that the messages are associated with a patentable concept. The system may receive feedback from the user, for example, to support further training the machine learning model, the embedding function, or both.

One or more technical solutions described herein may solve one or more technical problems by providing an improved graphical user interface (GUI) with improved usability, functionality, and user experience, an improved set of features, improved messaging, or some combination thereof for users of a group-based communication system. For example, the described techniques may support improved channel coordination, message analysis, and machine learning techniques. The machine learning model may support analyzing messages across one or more group-based communication channels for an organization within the group-based communication system to identify related technical discussions occurring within different teams (e.g., potentially independent of one another). Such analysis may support improved coordination across channels while maintaining organizational security. In some examples, the machine learning model may surface patent relevant information to a user (e.g., a patent professional) who otherwise may not have visibility into or access to the patent relevant information (e.g., based on channel settings). Additionally, or alternatively, the group-based communication system may leverage user feedback to improve machine learning processes (e.g., including an embedding function) to more accurately map between group-based communication message language and patent application language. For example, users posting messages to the group-based communication system may use significantly different language than drafters writing patent applications. The system may improve the accuracy of the embedding function by training the embedding function based on correlations between group-based communication messages and filed patent applications. The group-based communication system may further support an improved user interface providing patent-relevant affordances to improve the availability of training data for machine learning processes, the granularity of user feedback, and the identification of patent-relevant messages.

### BRIEF DESCRIPTION OF THE DRAWINGS

FIG. 1 illustrates an example of a system for cloud computing that supports identification of patent-relevant messages in a group-based communication system using machine learning techniques in accordance with aspects of the present disclosure.

FIGS. 2 and 3 illustrate examples of group-based communication systems that support identification of patent-relevant messages in a group-based communication system using machine learning techniques in accordance with aspects of the present disclosure.

FIG. 4 illustrates an example of an embedding space that supports identification of patent-relevant messages in a group-based communication system using machine learning techniques in accordance with aspects of the present disclosure.

FIG. 5 illustrates an example of a user interface that supports identification of patent-relevant messages in a group-based communication system using machine learning techniques in accordance with aspects of the present disclosure.

FIG. 6 illustrates an example of a process flow that supports identification of patent-relevant messages in a group-based communication system using machine learning techniques in accordance with aspects of the present disclosure.

FIG. 7 illustrates a block diagram of a device that supports identification of patent-relevant messages in a group-based communication system using machine learning techniques in accordance with aspects of the present disclosure.

FIG. 8 illustrates a block diagram of a patent relevancy manager that supports identification of patent-relevant messages in a group-based communication system using machine learning techniques in accordance with aspects of the present disclosure.

FIG. 9 illustrates a diagram of a system including a device that supports identification of patent-relevant messages in a group-based communication system using machine learning techniques in accordance with aspects of the present disclosure.

FIGS. 10 and 11 illustrate flowcharts showing methods that support identification of patent-relevant messages in a group-based communication system using machine learning techniques in accordance with aspects of the present disclosure.

### DETAILED DESCRIPTION

A group-based communication system may provide access to a group-based communication platform, which may in turn support multiple group-based communication channels. A group-based communication channel may provide a virtual space in which users of a group or team may communicate, for example, by posting messages, entering hangout meetings, performing calls, sharing files, or communicating using any other means. In some systems, a workspace or organization (e.g., a tenant of a multi-tenant database system or another organization or team) may use multiple different channels within the group-based communication platform. In some examples, a user may post a message (e.g., any type of post supported by the group-based communication system) to a group-based communication channel, such as a public or private channel with a list of members, a direct message conversation between a set of users, a huddle or other communication channel via the group-based communication system, or any other group-based communication channel. The message may potentially include content describing a technical idea that could be patent eligible. However, the users interacting with the message (e.g., posting the message, reading the message, responding to the message) may lack the legal knowledge to identify that the message—or a set of messages—is patent-relevant.

A group-based communication system may use machine learning techniques to automatically identify whether messages are patent-relevant. In some cases, users may post messages discussing potentially patentable concepts. To support automatic identification of these patent-relevant messages within the group-based communication system, the system may use a machine learning model including at least an embedding function. The embedding function may create an embedding space including embeddings of patent applications (e.g., portions of patent application documents). The system may trigger a patent-relevancy test for one or more messages (e.g., messages associated with a conversation within a group-based communication channel) based on a user posting a new message to the channel, a user tagging a message as being potentially patent-relevant, or some other trigger. For the patent-relevancy test, the group-based communication system may generate a set of features for the one or more messages and may input the set of features into the machine learning model. Using the embedding function, the model may create a message embedding and may compare the message embedding with patent application embeddings to determine a level of similarity. For example, the model may determine whether a distance between the message embedding and patent application embeddings within the embedding space (e.g., a vector space) satisfies a proximity threshold. Based on the embeddings, one or more additional features of the messages, or both, the machine learning model may output an indication of whether the one or more messages are associated with a patentable concept.

If the output indicates that the one or more messages are associated with a patentable concept, the group-based communication system may send, to a user device for display, an indication that the messages are predicted to be associated with a patentable concept. The user device may be operated by a user (e.g., a patent professional) who manages patent work for an organization of the group-based communication system. In some examples, the output may further indicate, to the user, additional information relating to the one or more messages, the patentable concept, or both. For example, the output may further indicate related patent applications, other relevant messages (e.g., from other group-based communication channels in the group-based communication system), a type of patent, a list of suggested inventors, the contents of the messages, or any combination thereof. The user may review the information received from the group-based communication system to determine whether to confirm or deny that the messages are associated with a patentable concept. The user may provide feedback to the group-based communication system, including a confirmation of the patentable concept, an indication of value to the organization, a confirmation of the inventor list, or any combination of these or other indications supporting further machine learning model training. The group-based communication system, or another system supporting machine learning, may receive the user feedback and may further train (e.g., tune for the specific organization, improve the mapping from group-based communication message language to patent application language) the machine learning model, the embedding function, or both based on the user feedback.

Aspects of the disclosure are initially described in the context of a system for cloud computing. Additional aspects of the disclosure are described with reference to group-based communication systems, an embedding space, a user interface, and a process flow. Aspects of the disclosure are further illustrated by and described with reference to apparatus diagrams, system diagrams, and flowcharts that relate to identification of patent-relevant messages in a group-based communication system using machine learning techniques.

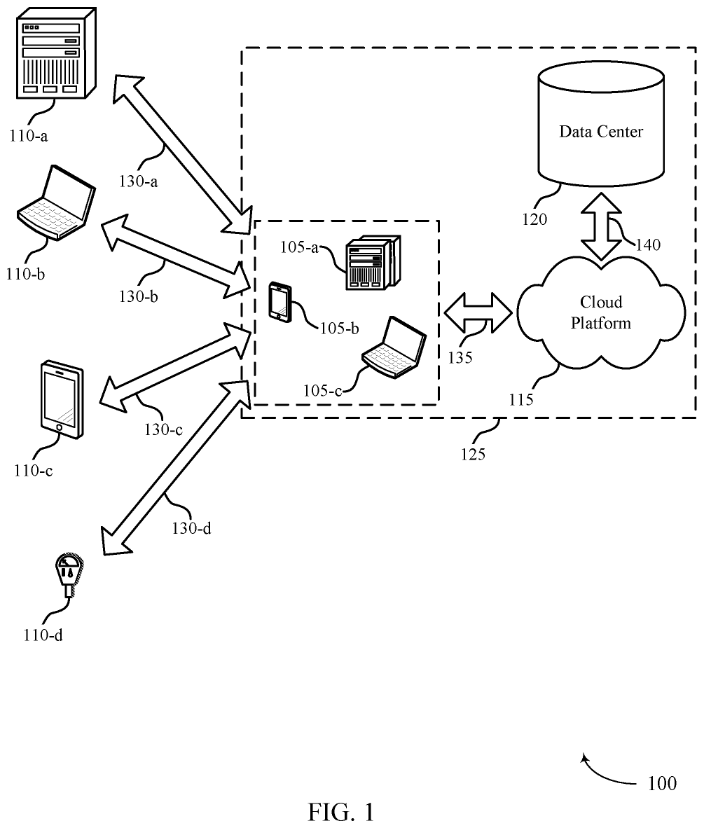

FIG. 1 illustrates an example of a system 100 for cloud computing that supports identification of patent-relevant messages in a group-based communication system using machine learning techniques in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may further support a group-based communication system. For example, a group-based communication system may provide a platform for users to communicate within groups or teams defined by group-based communication channels. The group-based communication system may leverage one or more aspects of the subsystem 125. For example, data objects stored in the data center 120, the cloud platform 115, or both may be accessed or otherwise referenced within a channel of the group-based communication system. Additionally, or alternatively, the cloud platform 115 may support a group-based communication platform.

Some other systems may rely on specific users (e.g., patent professionals or other users with extensive knowledge of patent law) to identify whether messages are discussing technical ideas that could be patentable. For example, a user may analyze every email chain that she is on to determine whether the emails support a patentable concept. Such a process may be extremely time-intensive and may potentially lead to missed patent ideas. Further, if the user is not included on an email chain, the user may not be able to determine if a patentable concept is discussed in the email chain. Additionally, if similar patentable concepts are discussed in different email chains (e.g., without any overlapping users), the connection between these concepts may be missed. Even if a system were to use a machine learning model, the model may fail to determine accurate similarities between messages and patent applications because of the differences in language and terms used in these types of text.

In contrast, the system 100 may use machine learning techniques that support improved channel coordination, message analysis, and embedding techniques specifically for identifying patent-relevant messages. The system 100 may include a machine learning model that may analyze messages across one or more group-based communication channels for an organization within the group-based communication system to identify related technical discussions occurring within different teams. Such analysis may support improved coordination across channels while maintaining organizational security. In some examples, the machine learning model may surface patent relevant information to a user (e.g., a patent professional) who otherwise may not have visibility into or access to the patent relevant information (e.g., based on channel settings). For example, the group-based communication system may override visibility settings or may trigger a request to grant a user (e.g., a patent professional) access to the relevant messages. Additionally, or alternatively, the group-based communication system may leverage user feedback to improve machine learning processes (e.g., including an embedding function) to more accurately map between group-based communication message language and patent application language. For example, the system may improve the accuracy of the embedding function by training the embedding function based on correlations between group-based communication messages and filed patent applications. The group-based communication system may further support an improved user interface providing patent-relevant affordances to improve the availability of training data for machine learning processes, the granularity of user feedback, and the identification of patent-relevant messages

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

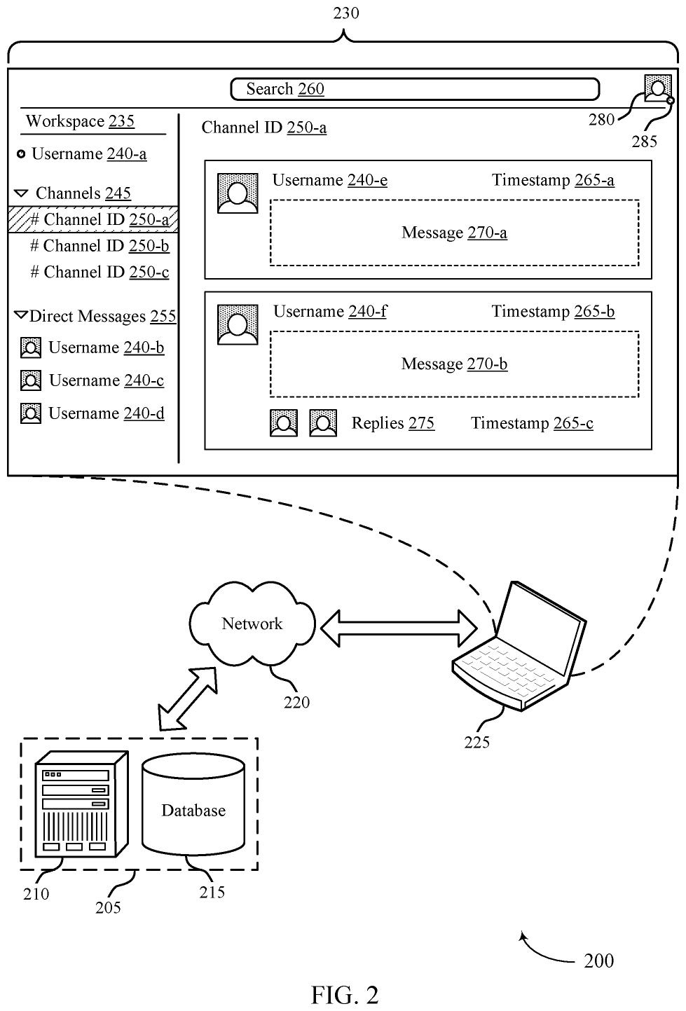

FIG. 2 illustrates an example of a group-based communication system 200 that supports identification of patent-relevant messages in a group-based communication system using machine learning techniques in accordance with aspects of the present disclosure. The group-based communication system 200 may be implemented as part of or with a system 100. For example, the group-based communication system 200 may leverage data stored at a cloud platform 115, a data center 120, or some combination thereof. The group-based communication system 200 may include a group-based communication platform 205 hosted by one or more computing devices 210, databases 215, or a combination thereof. The group-based communication system 200 may support displaying data to a user via a user interface 230 of a user device 225. In some examples, the user device 225 may communicate with the group-based communication platform 205 via a network 220. In some cases, the user device 225 may be an example of a cloud client 105 or a contact 110 in a system 100, as described with reference to FIG. 1.

The group-based communication platform 205 may leverage a network-based computing system to enable users of the group-based communication platform 205 to exchange data. By being “group-based,” the platform may support communication channels, messages, virtual spaces, or a combination thereof organized into groups of users. The group-based communication platform 205 may include security policies or features that define access to resources (e.g., channels, messages) according to such groups. In some examples, the groups of users may be defined by group IDs, which may be associated with common access credentials, domains, or the like. In some examples, the group-based communication platform 205 may provide a virtual space enabling users to chat, meet, call, collaborate, transfer files or other data, or otherwise communicate within groups. In some examples, a group may be associated with a workspace 235, enabling users associated with the group to communicate within the group in a secure and private virtual space. In some cases, members of a group or a workspace may be associated with a same organization (e.g., a tenant of a multi-tenant database system). In some other cases, members of a group or a workspace may be associated with different organizations (e.g., entities with different organization IDs, such as different tenants in a multi-tenant database system).

One or more computing devices 210 may support the group-based communication platform 205. For example, the one or more computing devices 210 may include an application server, a database server, a cloud-based server or service, a worker server, a server cluster, a virtual machine, a container, or any combination of these or other computing devices supporting data processing. For example, the one or more computing devices 210 may include one or more processors, memory, computer-readable media, or a combination thereof. The one or more computing devices 210 may perform functions and provide features as described herein with respect to the group-based communication platform 205. The group-based communication platform 205 may further include one or more databases 215, which may include cloud-based data storage, physical data storage, or both. In some cases, the one or more databases 215 may be memory components of the one or more computing devices 210. The one or more databases 215 may store data associated with the group-based communication platform 205. For example, the one or more databases 215 may include data relating to channels, users, workspaces 235, or any combination thereof, logs of messages 270, security information, or any other information relevant to the group-based communication platform 205.

A user may access the group-based communication platform 205 using a user device 225. The user device 225 may be an example of a laptop, a desktop computer, a smartphone, a tablet, a smart device, or any other device operated by a user and including a user interface 230. The user device 225 may communicate with the group-based communication platform 205, for example, via a network 220. The network 220 may be any type of communication network, such as a local area network or a wide area network, the Internet, a wireless network, a cellular network, a local wireless network, Wi-Fi, Bluetooth R, Bluetooth Low Energy (BLE), Near Field Communication (NFC), a wired network, or any combination of these or other networks. The network 220 may support proper network protocols for transferring data between the user device 225 and the group-based communication platform 205. For example, the user device 225, the group-based communication platform 205, or both may apply one or more security protocols (e.g., encryption) for securely transferring data over the network 220. In some cases, one or more aspects of the group-based communication platform 205 may be implemented at the user device 225. For example, the user device 225 may download an application corresponding to the group-based communication platform 205 and may store information relating to the group-based communication platform 205 locally at the user device 225. In some other examples, the user device 225 may access the group-based communication platform 205 in a web browser.

The user device 225 may include a user interface 230 that may display information relating to the group-based communication platform 205. Additionally, a user may interact with the user interface 230 to communicate with other users, view data, modify data, or otherwise perform actions associated with the group-based communication platform 205. The group-based communication platform 205 may support multiple group-based communication channels, and the user interface 230 may display information relating to a group-based communication channel corresponding to a channel ID 250-a. The user interface 230 may display a sidebar including navigation information for a user and a central pane (e.g., a main pane) including the channel contents, such as a sequential listing of messages 270 corresponding to the channel ID 250-a. A channel (e.g., a group-based communication channel) may provide a virtual space for a group of users to communicate via messages, hangouts, video or audio calls, files, or any other means of communication. The group of users may include members of the channel, non-members of the channel with access to the channel, or both.

A user may log into the group-based communication platform 205 (e.g., using a username 240-a, a password, or both corresponding to a user account). In response to the user logging in, the group-based communication platform 205 may send, for display in the user interface 230, data corresponding to the user (e.g., corresponding to an account for the user). For example, the user may be associated with a specific workspace 235, a set of channels 245, a set of connections, a set of threads, a set of direct messages 255, or any combination of these. The user device 225 may retrieve or otherwise access the relevant information for the user (e.g., based on the username 240-a or another user ID) and surface the information for display in the user interface 230 according to a display format.

As an example, in a sidebar (e.g., a navigation pane), the user interface 230 may display an indication of a workspace 235 corresponding to the user and the username 240-a of the user. The sidebar may further include indications of a set of channels 245 using the respective channel IDs. For example, the set of channels 245 may include the channels to which the user is a member. As illustrated, the set of channels 245 may include a first channel corresponding to a first channel ID 250-a, a second channel corresponding to a second channel ID 250-b, and a third channel corresponding to a third channel ID 250-c. It is to be understood that the set of channels 245 may include any quantity of channels for selection by the user. The user may select a channel from the listing of the set of channels 245, and the user interface 230 may display the selected channel (e.g., the messages 270) associated with the selected channel) in the central pane. The sidebar may further include a set of direct messages 255 between the user with the username 240-a and one or more other users (e.g., in a DM group). For example, the set of direct messages 255 may include the usernames 240 (or nicknames) of the users communicating via direct messages with the user. In some examples, the list of users may include users added by the user with username 240-a, users who have current, ongoing direct message conversations with the user with username 240-a, or both. As illustrated, the set of direct messages 255 may include indications of a user with a first username 240-b, a user with a second username 240-c, and a user with a third username 240-d, although any quantity of users may be include in the set of direct messages 255. Selecting a username 240 from the set of direct messages 255 may cause the user interface 230 to display a set of direct messages between the logged in user and the selected user or group of users in the central pane (e.g., direct messages that are stored in the system and displayed in a sequential order).

The central pane of the user interface 230 may display the contents of a selected channel. For example, if the user selects a channel with a channel ID 250-a, the central pane may display the selected channel ID 250-a, as well as data corresponding to this selected channel ID 250-a. The data for the channel may include a sequential listing of messages 270) posted to the channel. For example, a user with a username 240-e may post a first message 270-a at a first time corresponding to a timestamp 265-a. The user interface 230 may display, for the channel, this information, as well as affordances supporting actions associated with this information. For example, a user may react to the message 270-a, reply to the message 270-a, or both. As illustrated, another user with a username 240-f may post a second message 270-b at a time corresponding to a timestamp 265-b, and one or more users may reply to the message 270-b. The user interface 230 may indicate a set of replies 275 and one or more timestamps 265-c associated with the replies 275 (e.g., a timestamp 265-c corresponding to a most recent reply) with the message 270-b. Selecting the set of replies 275 may cause the user interface 230 to display the replies in a second sidebar (e.g., as a thread of messages).

The messages 270) may include text or other objects, such as files, photos, audio files, video files, documents, uniform resource locator (URL) links, or any other objects. If the selected channel is private, member of the channel may view the information related to the channel, while nonmembers of the channel may be blocked from viewing the information. If the selected channel is public, members and nonmembers of the channel may view the relevant information. In some cases, channels, users, workspaces 235, accounts, or some combination thereof may include accessibility settings or rules with may define viewing capabilities, editing capabilities, or both.

The user interface 230 may further support search functionality using a search bar 260. Additionally, or alternatively, the user interface 230 may indicate a profile picture 280 of the currently logged in user, as well as a connection status 285 (e.g., online, offline, busy) of the user.

In the group-based communication system 200, users may post messages discussing potentially patentable concepts. To support automatic identification of patent-relevant messages within the group-based communication system 200, the system may use a machine learning model including at least an embedding function. The system may generate a set of features for one or more messages and may input the set of features into the machine learning model. Using the embedding function, the model may create a message embedding and may compare the message embedding with embeddings of patent application language to determine a level of similarity. The machine learning model may output an indication of whether the one or more messages are associated with a patentable concept based on the embedding, and the indication may be surfaced to a user (e.g., a user with a username 240-a operating a user device 225) via a user interface 230 for review.

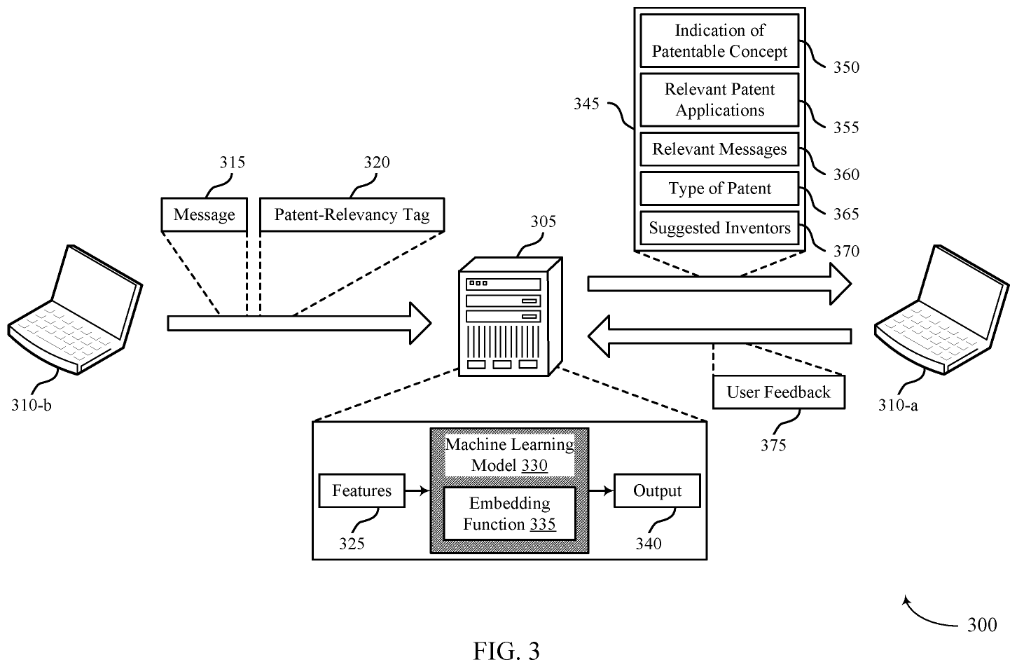

FIG. 3 illustrates an example of a group-based communication system 300 that supports identification of patent-relevant messages in a group-based communication system using machine learning techniques in accordance with aspects of the present disclosure. The group-based communication system 300 may be an example of a group-based communication system 200 as described herein with reference to FIG. 2. The group-based communication system 300 may include a computing device 305 that supports a group-based communication platform. The computing device 305 may be an example of any processing device or apparatus, such as an application server, a database server, a cloud-based server or service, a worker server, a server cluster, a virtual machine, a container, a network device, a user device, or any combination of these or other computing devices. The group-based communication system 300 may support user devices accessing the group-based communication platform. For example, a first user device 310-a and a second user device 310-b may allow users of the group-based communication platform to access group-based communications. The first user device 310-a and the second user device 310-b may be examples of user devices 225 as described herein with reference to FIG. 2. The group-based communication system 300 may identify potentially patentable concepts mentioned or discussed within messages of the group-based communication system 300.

The first user device 310-a may be operated by a first user associated with managing patents for an organization (e.g., a workspace, team, or tenant within the group-based communication system). For example, the first user may be an example of a patent attorney, a patent agent, a product manager, or any other user who can make decisions regarding patent work for the organization. The second user device 310-b may be operated by a second user who is also a member of the organization. In some cases, the second user may be a potential inventor. For example, the second user may use the group-based communication platform to discuss technical products, new ideas, potential updates, experiments, inventions, or any combination thereof with other users of the organization (e.g., within one or more group-based communication channels of the group-based communication system 300). The discussions between users may potentially include concepts that could be patentable by the organization. However, the users discussing these concepts may lack the technical or legal knowledge to identify when a discussed topic (e.g., a product, a tool, a user interface) could support a valuable patent for the organization. Further, the first user associated with managing patents for the organization may not be a member of a group-based communication channel in which other users are discussing patentable concepts. Additionally, or alternatively, the organization may include a quantity of channels (e.g., hundreds or thousands of channels) that is unmanageable for the first user.

The group-based communication system 300 may support a machine learning model 330 trained to identify whether one or more messages 315 are associated with a patentable concept. The machine learning model 330 may include at least an embedding function 335 (e.g., an embedding model) to support embedding messages 315 into an embedding space. For example, the embedding function 335 may support vector embedding into a vector space. The embedding function 335 may be trained with embeddings of patent applications (e.g., full patent applications, portions of patent applications), such that message embeddings may be compared to patent application embeddings within the embedding space to support determining whether the messages 315 include similar language or concepts to the patent applications.

In some examples, a user operating the second user device 310-b may post a message 315 to the group-based communication platform. The message 315 may be an example of a message posted to a group-based communication channel (e.g., a channel or direct messaging conversation), a reply posted to a group-based communication channel, a file posted to a group-based communication channel, a description written for a group-based communication channel, an update to a channel space or other collaborative document within the group-based communication platform, or any combination thereof. In some cases, posting the message 315 to the group-based communication platform may trigger a patent-relevancy test using the machine learning model 330 (e.g., at the computing device 305).

Additionally, or alternatively, the user operating the second user device 310-b may tag a message within the group-based communication platform with a patent relevancy tag 320. For example, the group-based communication platform may support a user interface displaying a patent-relevancy icon with a respective message. Clicking on the patent-relevancy icon via the user interface may tag the message with the patent relevancy tag 320. For example, the user may wonder whether the message (or a conversation including the message) may potentially include patentable subject matter and may select the patent relevancy tag 320 to trigger a patent-relevancy test for the message using the machine learning model 330 (e.g., at the computing device 305).

The patent-relevancy test may involve generating a set of features 325 for one or more messages 315. In some cases, the computing device 305 may determine one or more messages 315 to test. In some examples, the computing device 305 may test a single message (e.g., a single message 315 posted to the group-based communication platform or a single message tagged with a patent relevancy tag 320). In some other examples, the computing device 305 may test a message and a set of replies to the message. In yet some other examples, the computing device 305 may test a set of messages within a group-based communication channel (e.g., a channel or direct message conversation). For example, the computing device 305 may test all of the messages in the channel or may select a subset of messages from the channel to test based on determining which messages relate to a similar idea or topic (e.g., using conversation segmenting techniques).

The computing device 305 may generate the set of features 325 based on the determined one or more messages 315. The set of features 325 may include an indication of a user associated with a message of the one or more messages 315 (e.g., a user who posted the message, a user who has access to the message, a user who replies or reacted to the message, a user who tagged the message with the patent relevancy tag 320, a quantity of users who interacted with the message). In some examples, the set of features 325 may include an indication of the group-based communication channel to which the one or more messages 315 were posted, such as the channel ID, a type of the channel (e.g., public or private, a tag for the channel), a description of the channel, a quantity of messages posted to the channel, or any combination thereof. Additionally, or alternatively, the set of features 325 may include information relating to the messages of the one or more messages 315, such as raw text data from the messages, a message length, whether a file is attached to a message, a quantity of replies to a message, or any combination thereof.

The computing device 305 may input the set of features 325 into the machine learning model 330. Additionally, or alternatively, the computing device 305 may create an embedding for the one or more messages 315 (e.g., a single embedding for a set of messages or separate embeddings for each message). In some cases, the embedding function 335 may use one or more of the features 325 to perform the embedding. The embedding may be based on the text of a message, including the body of the message, a subject of the message, text from a file attached to the message, or any combination thereof. Using the embedding function 335, the computing device 305 may map the one or more messages 315 into an embedding space (e.g., a vector space). The computing device 305 may compare the embedding of the one or more messages 315 to embeddings of patent applications (e.g., at least portions of patent applications) within the embedding space to determine a similarity between the one or more messages 315 and patent applications. The computing device 305 may use a cosine similarity, an approximate nearest-neighbor search, or any other technique for comparison. The computing device 305 may use the comparison to determine whether the one or more messages 315 are associated with a patentable concept. For example, the machine learning model 330 may use the embedding to determine an output 340 of the machine learning model 330. In some cases, the machine learning model 330 may use one or more features 325 in addition to the embedding to determine the output 340. For example, the machine learning model 330 may be an example of an embedding model or may use an embedding model to create one or more inputs for an additional machine learning process (e.g., a classification model or neural network).

The machine learning model 330 may be trained by the group-based communication system or by some other machine learning system. In some examples, the group-based communication system 300 may use a single machine learning model 330) across teams and organizations (e.g., potentially using a team, organization, or workspace ID as a feature). In some other examples, the group-based communication system 300 may use organization-specific machine learning models 330 to securely handle data (e.g., model training data, user feedback 375) for each organization. The machine learning model 330 may be an example of a logistic regression model, a classification model, a random forest model, a neural network (e.g., a feed forward (FF) or deep feed forward (DFF) neural network, a recurrent neural network (RNN), a long/short term memory (LSTM) neural network, or any other type of neural network), or any other machine learning model or heuristic. In some cases, the machine learning model 330 may be an example of a classification model (e.g., a neural network) configured to identify whether one or more messages 315 are potentially patent relevant. The embedding function 335 may involve any natural language processing (NLP) techniques, such as binary encoding, term frequency (TF) encoding, TF-inverse document frequency (IDF) encoding, latent semantic analysis encoding, Word2Vec embedding, or any other form of embedding (e.g., word, phrase, language, or semantic embedding).

The output 340 may include an indication of whether the machine learning model 330 predicts that the one or more messages 315 used to generate the set of features 325 are associated with a patentable concept. The one or more messages 315 may be associated with a patentable concept if the messages discuss a new technology, product, update, or invention that is similar to previously-filed patent applications. In some examples, the machine learning model 330 may confirm that the one or more messages 315 discuss a process, a machine, a manufacture, or a composition of matter. Additionally, or alternatively, the machine learning model 330) may confirm that the subject matter discussed in the one or more messages 315 is patent eligible (e.g., according to a patent eligibility test). In some cases, the indication of the patentable concept 350) may be a binary value (e.g., a classification) indicating whether or not the one or more messages 315 are associated with a patentable concept. In some other cases, the indication of the patentable concept 350 may be a decimal value indicating a confidence of whether the one or more messages 315 are associated with a patentable concept. For example, a decimal value nearer to 1.0 may indicate relatively greater confidence that the one or more messages 315 are associated with a patentable concept, while a decimal value nearer 0.0 may indicate relatively greater confidence that the one or more messages 315 are not associated with a patentable concept. A decimal value near 0.5 may indicate relatively poor confidence in a prediction by the machine learning model 330. In some cases, the indication of the patentable concept 350 may include a novelty rating for the patentable concept (e.g., a decimal value indicating how novel the idea appears to be). The indication of the patentable concept 350 may additionally include or otherwise indicate the one or more messages 315 used to generate the set of features 325 for the patent-relevancy test.

Additionally, or alternatively, the output 340 may indicate more granular information regarding the patentable concept. For example, the output 340 may indicate relevant patent applications 355 similar to the patentable concept. For example, the machine learning model 330 may determine patent applications corresponding to embeddings within the embedding space that are within a threshold distance from the message embedding and may surface an indication of these patent applications for review. Alternatively, the machine learning model 330 may determine the N patent applications with embeddings closest to the message embedding within the embedding space and may surface an indication of these patent applications (e.g., the 5 most similar patent applications). In some examples, the machine learning model 330 may predict a type of patent 365 associated with the patentable concept. The type of patent 365 may be a process, a machine, a manufacture, or a composition of matter. Alternatively, the type of patent 365 may be a relatively more granular indication of a technology or art unit (e.g., database technology, artificial intelligence, computer networking, encryption, or any other technology group indicating an art unit). The machine learning model 330 may predict the type of patent 365 based on the embedding space (e.g., based on the types of patent applications with embeddings relatively proximate to the message embedding).

In some examples, the machine learning model 330 may indicate a list of suggested inventors 370. The machine learning model 330 may determine the suggested inventors 370 based on users associated with the one or more messages 315 used to generate the set of features 325. For example, the machine learning model 330 may suggest users as potential inventors based on a user posting a message that discusses the patentable concept, based on a user authoring a file that discusses the patentable concept, based on a user being a member of a group-based communication channel (e.g., channel or direct messaging conversation) that discusses the patentable concept, or some combination thereof.

In some examples, the machine learning model 330) may indicate other relevant messages 360) potentially associated with the patentable concept. For example, the computing device 305 may search other group-based communication channels (e.g., channels or direct messaging conversations) for group-based communication messages that include similar language to the one or more messages 315 used to generate the set of features 325 for the patent-relevancy test. In some examples, the computing device 305 may search group-based communication channels with relevant channel descriptions or overlapping members (e.g., one or more users associated with the one or more messages 315 used to generate the set of features 325). Alternatively, the computing device 305 may search all other group-based communication channels or a subset of group-based communication channels based on relevant text. In some cases, a first team of users may discuss an idea using a first group-based communication channel within the organization. However, a second team of users (e.g., with a subset of overlapping users or fully distinct teams) may discuss a similar idea using a second group-based communication channel within the organization. If the idea discussed by the first team is determined to be associated with a patentable concept, the machine learning model 330 may surface the other relevant messages 360 posted by the second team to support additional details relating to the patentable concept, ensure correct inventorship, mitigate the potential for prior art within the organization, or some combination thereof. As such, the group-based communication system 300 may support improved coordination of patentable ideas across groups (e.g., teams) while maintaining security within an organization. For example, the relevancy of other messages or channels may not be surfaced to the users posting the messages, but instead may be managed by the user associated with managing patents for the organization (e.g., to avoid potential security concerns between teams or channels).

The group-based communication system 300 may surface the output 340 of the machine learning model 330 to the user associated with managing patents for the organization (e.g., the first user operating the first user device 310-a). For example, the computing device 305 may send, to the user device 310-a for display via a user interface, one or more indications of the output 340. The computing device 305 may send, to the user device 310-a for display, the indication of the patentable concept 350), the indication of relevant patent applications 355, the indication of other relevant messages 360, the indication of the type of patent 365, the indication of suggested inventors 370, or any combination thereof within a patent suggestion item 345. In some cases, the group-based communication platform may support a queue of patent suggestion items 345 or some other format for the first user to review and analyze the patent suggestion items 345 indicated by the machine learning model 330.

A patent suggestion item 345 may include the one or more messages 315 used to generate the set of features 325 for the patent-relevancy test. The first user may review these one or more messages 315 via the user interface of the user device 310-a and may determine whether the one or more messages 315 support the indicated patentable concept. In some examples, the user device 310-a may display the one or more messages 315 even if the first user does not have access to the relevant group-based communication channel (e.g., to ensure the first user can accurately judge whether the messages support a patentable concept). In some other examples, the group-based communication system 300 may maintain access and permission settings. As such, the computing device 305 may refrain from sending the one or more messages 315 for display at the first user device 310-a if the first user does not have permission to view the one or more messages 315. In some such other examples, the computing device 305 may trigger messaging one or more users associated with the one or more messages 315 or the corresponding group-based communication channel to request that a user grants the first user access to the one or more messages 315 (e.g., to evaluate whether the one or more messages 315 are associated with a patentable concept).

The first user may provide user feedback 375, via the user interface of the user device 310-a, about the patent suggestion item 345. For example, the first user may confirm or reject that the one or more messages 315 are associated with the patentable concept. In some cases, the first user may provide more structured feedback indicating additional information for model training. For example, the first user may indicate whether the patentable concept is valuable to the organization (e.g., a concept the first user plans to pursue by filing a patent application). The user feedback 375 may differentiate between non-technical conversations (e.g., messages involving chats between users), technical conversations that are not patent-relevant, technical conversations that are associated with a patentable concept, technical conversations that are associated with a patentable concept valuable to the organization (e.g., that the organization plans to pursue with a patent application filing), or any combination thereof. In some examples, the first user may update the list of suggested inventors 370 based on analyzing the one or more messages 315 and the actual contributions of the different users. Additionally, or alternatively, the first user may indicate a concern regarding prior art for the patentable concept (e.g., based on the relevant patent applications 355). If the organization files a patent application for the patentable concept, the first user may tag the patent suggestion item 345 (or the one or more messages 315) to indicate that a patent application was filed. In some examples, the tag may be updated to indicate if the filed patent application is allowed (e.g., manually updated by the first user or automatically updated based on a communicate from the Patent Office). Any such information may be provided back to the group-based communication system 300, or another system for machine learning, as user feedback 375.

The group-based communication system 300, or another system for machine learning, may use the user feedback 375 to update the machine learning model 330, the embedding function 335, or both. For example, a system may further train the machine learning model 330 using the user feedback 375 (e.g., to tune the model to the first user's or the organization's specific interests). In some cases, the machine learning model 330 may be trained to more accurately determine whether messages are associated with patentable concepts. Additionally, or alternatively, the machine learning model 330 may be trained to determine whether a patentable concept is likely to be valuable for the specific organization. In some cases, the machine learning model 330 may be trained to improve determining relevant patent applications 355, other relevant messages 360, the type of patent 365, the suggested inventors 370, or any combination thereof, for examples, based on the user feedback 375 confirming or denying previous model outputs.

In some examples, the group-based communication system 300, or another system for machine learning, may improve the embedding function 335 by improving a correlation between group-based communication message language and patent application language. Users posting messages to the group-based communication system 300 may use different language, syntax, voice, level of formality, or some combination thereof as compared to someone drafting a patent application. As such, simply embedding group-based communication messages and portions of patent applications into an embedding space using a same embedding function 335 may result in inefficiencies or inaccuracies. To improve (e.g., finely tune) this embedding, a system may determine an embedding function 335 that accounts for the differences between group-based communication messages and patent applications. For example, the user feedback 375 may indicate messages that resulted in patent application filings. The system may analyze the language of the messages and the language of the resulting patent applications to determine an improved embedding function 335 that maps from group-based communication message language to patent application language. Such a mapping may indicate how group-based communication message language may be transformed into patent application language. For example, the improved embedding function 335 may support mapping one or more messages that led to a patent application filing to a similar embedding as the resulting patent application's embedding within the embedding space (e.g., within a threshold or negligible difference). Accordingly, the group-based communication system 300 may support an embedding space that mitigates the differences in language used for group-based communication messages and patent applications in order to more accurately support comparisons of the relevant subject matter.

Additionally, or alternatively, the group-based communication system 300 may use the user feedback 375 to identify users, group-based communication channels, teams, or any combination thereof that frequently produce patentable ideas (e.g., as compared to other users, channels, or teams). The group-based communication system 300 may tag such users, channels, or teams as prolific patent contributors. In some cases, the machine learning model 330, the embedding function 335, may be further trained to adjust weights associated with these users, channels, or teams (e.g., to represent the likelihood that messages associated with these users, channels, or teams may lead to patent application filings).

In some examples, the group-based communication system 300 may use a similar process to detect other legal information. For example, the group-based communication system 300 may support a machine learning model (e.g., the same or a different model) to determine if one or more messages are associated with a concept that could be trademarked, a concept that could be kept as a trade secret, or both. Additionally, or alternatively, the group-based communication system 300 may detect regulatory concerns, patent infringement concerns, potential prior art documents, or any combination thereof (e.g., using similar machine learning techniques, embedding techniques, or both).

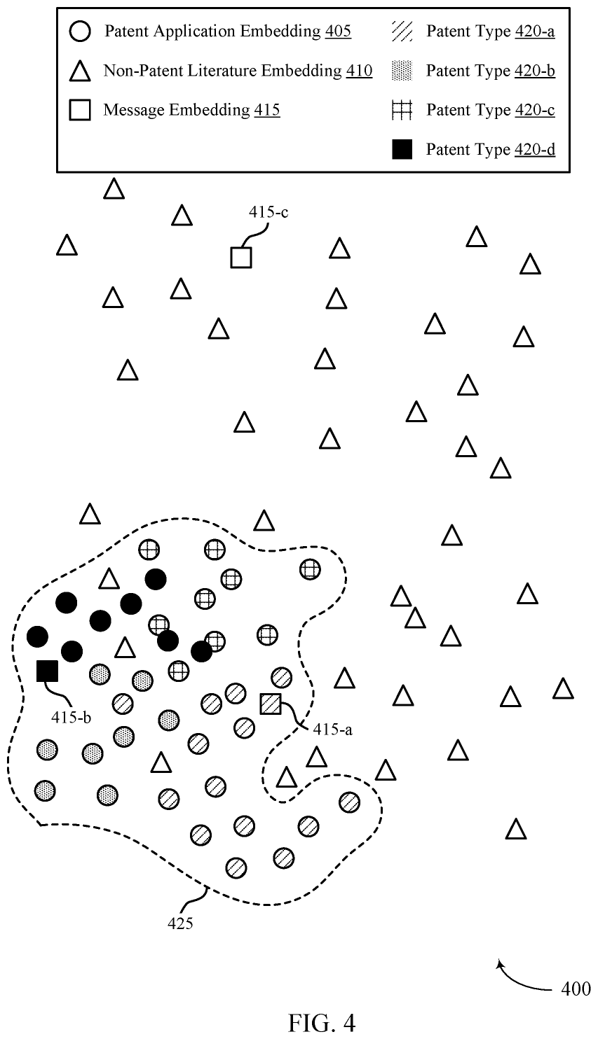

FIG. 4 illustrates an example of an embedding space 400 that supports identification of patent-relevant messages in a group-based communication system using machine learning techniques in accordance with aspects of the present disclosure. An embedding function, such as an embedding function 335 described herein with reference to FIG. 3, may map information into the embedding space 400. A group-based communication system, such as a group-based communication system 200 or a group-based communication system 300, may use the embedding space 400 to determine similarities between group-based communication messages and patent applications. For example, the embedding space 400 may include patent application embeddings 405, non-patent literature embeddings 410, message embeddings 415 (e.g., group-based communication message embeddings), or any combination thereof. These embeddings may be examples of vectors mapped into a vector space (e.g., the embedding space 400) or any quantity of dimensions.

The group-based communication system, or another system supporting machine learning techniques, may determine (e.g., train or otherwise learn) an embedding function (e.g., an embedding model or other machine learning model) using a corpus of patent applications. For example, the system may retrieve the corpus of patent applications from a patent registry or other publicly-available database. In some cases, the corpus of patent applications may be a random—or pseudo-random—selection of patent applications. In some other cases, the corpus of patent applications may be a filtered subset of patent applications based on a filter criterion. For example, the system may filter the patent applications by art unit, technology group, patent type, issued patents, rejected patent applications, or any other identifying parameter. Such filtering may result in an embedding function that can identify specific types of patents (e.g., patentable concepts corresponding to a specific art unit, technology group, or other patent type). Additionally, or alternatively, the system may use one or more identifying parameters for the patent applications to support further determinations of patent types within the embedding space. For example, the embedding function may label or otherwise identify which patent application embeddings 405 within the embedding space 400 correspond to first patent type 420-a, which correspond to a second patent type 420-b, which correspond to a third patent type 420-c, and which correspond to a fourth patent type 420-d. In some examples, the patent types may be a process, a machine, a manufacture, and a composition of matter. In some other examples, the patent types may be medical device patents, software patents, database patents, and hardware patents, or any other technology groupings. The embedding space 400 may support any quantity of patent types, embeddings, or both.

In some cases, the corpus of patent applications may include full patent applications. In some other cases, the corpus of patent applications may include portions of patent applications. The system may retrieve the portions of patent applications to reduce processing overhead (e.g., as compared to retrieving full patent applications). The portions of the patent applications used for training the embedding function may include an abstract, a summary, a detailed description, claims, a background, a brief description, drawings, or any combination thereof. The trained embedding function may map the portion of a patent application into the embedding space 400.

The system may further train the embedding function using non-patent literature. The non-patent literature may include technical documents (e.g., not associated with any patent filings), non-technical documents, messages (e.g., emails, text messages, voice call transcripts, social media posts, group-based communication messages as described herein with reference to FIG. 2), or any combination of these or other language not relating to a patent application.

By training the embedding function using patent applications and non-patent literature, the embedding function may generally group patent application embeddings 405 within the embedding space 400. For example, patent applications may correspond to a region 425 within the embedding space 400. In some cases, the system may determine the region 425 based on a centroid of the patent application embeddings 405, based on centroids of patent application embeddings 405 of different patent types, or both. The system may account for outliers when determining the region 425, such that the region 425 may not include all patent application embeddings 405, may include some non-patent literature embeddings 410, or both. In some examples, a machine learning model (e.g., a model including the embedding function) may use the region 425 to identify whether a message embedding 415 is associated with a patentable concept. Additionally, or alternatively, the machine learning model may use one or more distance thresholds (e.g., vector distances) within the embedding space 400 to identify whether a message embedding 415 is associated with a patentable concept.

The group-based communication system may use the trained embedding function to identify whether one or more messages (e.g., group-based communication messages) are associated with a patentable concept, for example, as described with reference to FIG. 3. The embedding function may map one or more first messages to a first message embedding 415-a within the embedding space 400. The group-based communication system may determine that the one or more first messages are likely to be associated with a patentable concept based on a distance associated with the first message embedding 415-a and the patent application embeddings 405 satisfying a proximity threshold. For example, the first message embedding 415-a may satisfy the proximity threshold based on being within the region 425 corresponding to patent applications. Additionally, or alternatively, the first message embedding 415-a may satisfy the proximity threshold based on being within a threshold distance from a centroid of the patent application embeddings 405.

In some cases, the embedding space 400 may account for patent ideas being too similar. For example, if messages are associated with a patentable concept that is identical (or nearly identical) to an already filed patent application, filing a new patent application attempting to claim this patentable concept may be rejected. In such cases, the group-based communication system may use a minimum distance threshold to ensure differences between patentable concepts. For example, the first message embedding 415-a may satisfy the proximity threshold based on a distance between the first message embedding 415-a and a patent application embedding 405 (e.g., each patent application embedding 405) being greater than a threshold distance. In some cases, the group-based communication system may additionally check whether the first message embedding 415-a is far enough away from other previous message embeddings 415 (e.g., based on the threshold distance).

The embedding function may additionally map one or more second messages to a second message embedding 415-b and one or more third messages to a third message embedding 415-c within the embedding space 400. As illustrated, the one or more second messages may also be associated with a patentable concept, while the one or more third messages may not be associated with a patentable concept based on the locations of the embeddings within the embedding space 400. In some cases, the group-based communication system may further use the embedding space 400 to provide additional details regarding the patentable concepts. For example, based on the patent application embeddings 405, the system may determine that the first message embedding 415-a corresponds to a first patent type 420-a and the second message embedding 415-b corresponds to a fourth patent type 420-d. Additionally, or alternatively, the embedding space 400 may indicate other information based on one or more parameters of the patent applications embedded into the embedding space 400. For example, the embedding function may track which embeddings (or which regions within the embedding space 400) correspond to rejected or abandoned patent applications. Based on the proximity of a message's embedding to a rejected or abandoned patent application embedding 405, the group-based communication system may predict potential concerns or relevant rejections corresponding to a patent application filed for the message. For example, if a message embedding 415 is within a proximity threshold of a patent application embedding 405 for a patent application that was rejected under 35 U.S.C. § 103 to a set of references, the group-based communication system may predict that a patent application filed for the relevant message may potentially also result in a 35 U.S.C. § 103 rejection, and the set of references may potentially be relevant prior art. Accordingly, the embedding space 400 may support determining whether one or more messages (e.g., group-based communication messages) are associated with a patentable concept and in some cases may provide additional granular information regarding predictions for patent prosecution.

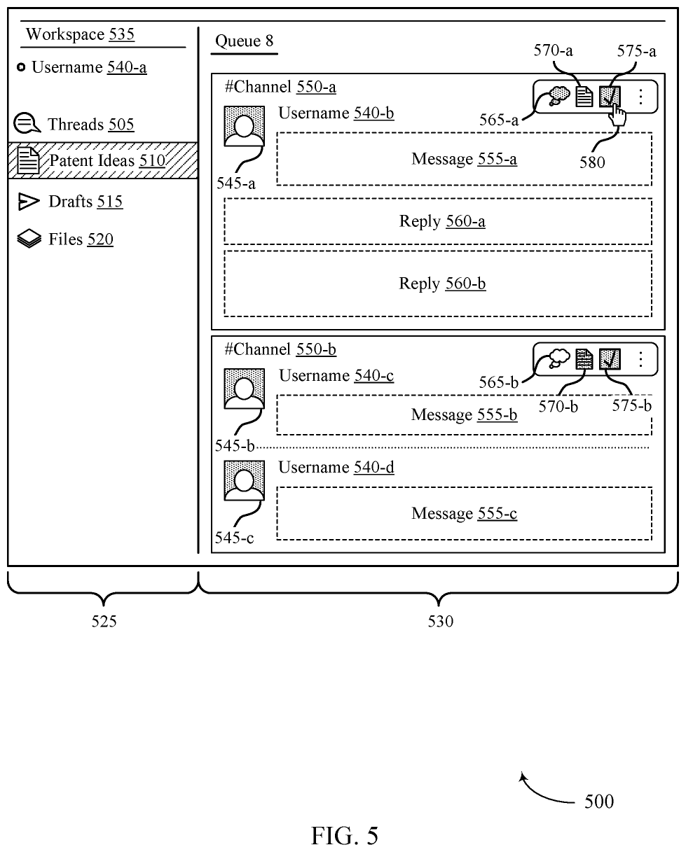

FIG. 5 illustrates an example of a user interface 500 that supports identification of patent-relevant messages in a group-based communication system using machine learning techniques in accordance with aspects of the present disclosure. The user interface 500 may be an example of a user interface 230 as described with reference to FIG. 2. For example, the user interface 500 may display, at a user device, group-based communication messages for a specific user of a group-based communication system. For example, a user with a username 540-a and included within a workspace 535 (e.g., an organization or team) may log into a group-based communication platform. Using a sidebar 525, the user may select a user view for display via a main pane or central pane 530. In some cases, the user may select to view a group-based communication channel within the central pane 530. In some other cases, the user may select to view a direct message conversation between one or more users within the central pane 530. In yet other cases, the user may select to view a different user view within the central pane 530.

For example, the group-based communication system may support a threads 505 user view, a patent ideas 510 user view, a drafts 515 user view; a files 520 user view, or some combination of these or other user views. In some cases, a subset of users may have access to the patent ideas 510 user view. For example, users indicated as patent professionals within the organization may have access to the patent ideas 510 user view. As illustrated, the user may select, via the sidebar 525, to view the patent ideas 510 user view within the central pane 530.

The patent ideas 510 user view may indicate a quantity of patent suggestion items within the queue for review (e.g., eight patent suggestion items). Each patent suggestion item may be associated with one or more messages that were determined to be associated with a patentable concept, as described herein with reference to FIGS. 3 and 4. The patent ideas 510 user view may provide a user interface for a user (e.g., a patent professional or other user managing patents for an organization) to review and provide feedback regarding the patent suggestion items identified by a machine learning model (e.g., the machine learning model 330 described with reference to FIG. 3).

For example, a first patent suggestion item in the queue may correspond to a message 555-a, a first reply 560-a to the message 555-a, and a second reply 560-b to the message 555-a. A user with a username 540-b and a profile picture 545-a may have posted the message 555-a to a group-based communication channel with a channel ID 550-a. A second patent suggestion item in the queue may correspond to a message 555-b and a message 555-c (e.g., a conversation segment identified within a group-based communication channel with a channel ID 550-b). A first user with a username 540-c and a profile picture 545-b may have posted the message 555-b, and a second user with a username 540-d and a profile picture 545-c may have posted the message 555-c. The patent ideas 510 user view may surface this information, or a subset of this information, to the user for review, analysis, and confirmation. The patent ideas 510 user view may additionally, or alternatively, display other information relating to the patent suggestion items.

The patent ideas 510 user view may additionally support input options for the patent suggestion items. For example, the user interface 500 may display a set of icons representing options for the user. The patent ideas 510 user view may display an “Is this a patent?” tag (e.g., a reaction, an emoji, a checkbox, or any other affordance), a confirmation tag, a “This was patented” tag, or any combination of these or other options (e.g., where more options may be supported by a dropdown affordance). If a user selects the “Is this a patent?” tag (e.g., a patent relevancy tag), the group-based communication system may trigger a patent-relevancy test for the corresponding message or set of messages. For example, the “Is this a patent?” tag may be visible or otherwise available in other group-based communication channels, such that a user who is wondering whether a message includes a patentable concept may select the tag to trigger review (e.g., a manual review by a patent professional or an automated review by a machine learning model). The confirmation tag may be supported within the patent ideas 510 user view and may allow a user (e.g., a patent professional) to confirm or deny that the one or more messages are associated with a patentable concept. The “This was patented” tag may be supported within the patent ideas 510 user view and may allow the user to indicate if a patent application was filed based on the one or more messages. Indications of the selected tags may be fed back to support further machine learning model training. The user may additionally remove patent suggestion items from the queue (e.g., following review of the items).

As illustrated, the “Is this a patent?” tag 565-a may be selected for the first patent suggestion item in the queue, indicating that a user triggered the patent-relevancy test using this tag. The confirmation tag 575-a may be selected for the first patent suggestion item (e.g., by clicking on the icon using a mouse 580), confirming that the message 555-a, the first reply 560-a, the second reply 560-b, or a combination of these messages are associated with a patentable concept. The “This was patented” tag 570-a may be selected for the first patent suggestion item, indicating that a patent application was filed corresponding to the patentable concept associated with these messages. For the second patent suggestion item, the “Is this a patent?” tag 565-b may be unselected (e.g., the patent-relevancy test may have been triggered based on some other trigger, such as the message 555-c being posted), the confirmation tag 575-b may be selected (e.g., confirming that the message 555-b, the message 555-c, or both are associated with a patentable concept), and the “This was patented” tag 570-b may be unselected (e.g., indicating that a patent application has not yet been filed corresponding to the patentable concept associated with these messages).

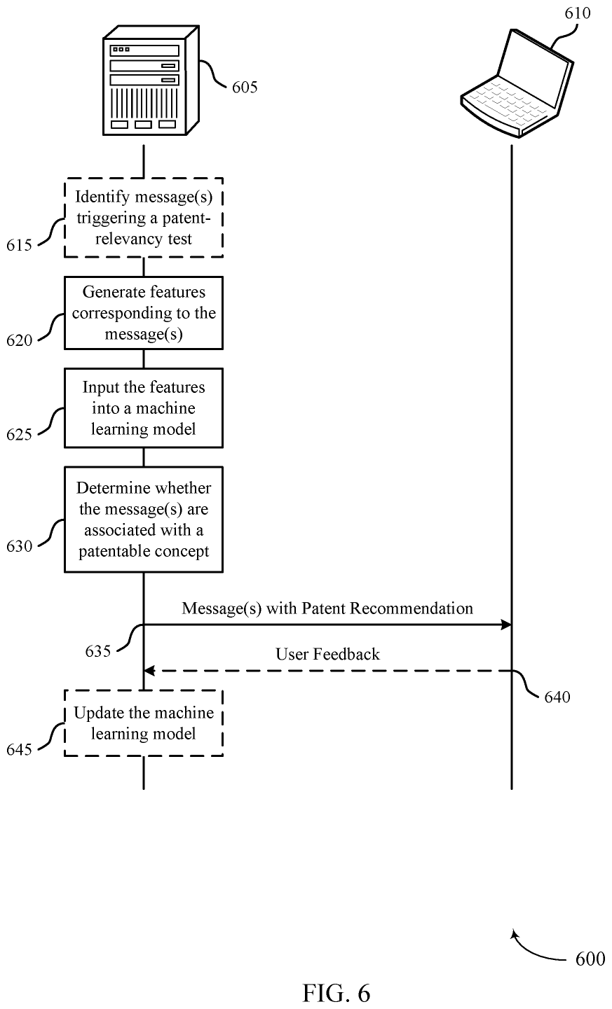

FIG. 6 illustrates an example of a process flow 600 that supports identification of patent-relevant messages in a group-based communication system using machine learning techniques in accordance with aspects of the present disclosure. The process flow 600 may be implemented by a group-based communication system including one or more computing devices 605 and one or more user devices 610. The computing device 605 (e.g., a processing device or system) may host a group-based communication platform. The computing device 605 may be an example of an application server, a database server, a cloud-based server or service, a worker server, a server cluster, a virtual machine, a container, a network device, a user device, or any combination of these or other computing devices or systems. The user device 610 may access the group-based communication platform over a network, based on downloading an application, or both. The user device 610 may be an example of a laptop, desktop computer, mobile device, smartphone, smartwatch, tablet, virtual reality (VR) device, or any combination thereof. The user device 610 may include a user interface (e.g., GUI) that can present information (e.g., visually, audibly) corresponding to the group-based communication system, as described herein with reference to FIGS. 1 through 5. Alternative examples of the following may be implemented, where some processes are performed in a different order than described or are not performed at all. In some examples, processes may include additional features not mentioned below, or further processes may be added. Additionally, or alternatively, one or more operations described herein as performed by the computing device 605 may instead be performed by the user device 610, for example, if the user device 610 runs a group-based communication platform application locally.

The computing device 605, the user device 610, or both may run the group-based communication system platform. A user device 610 may display, via a user interface, one or more visual panes including information relating to the group-based communication platform, as described herein with reference to FIG. 2.

At 615, the computing device 605 may identify one or more messages for a patent-relevancy test. In some examples, a user may post a new message to a group-based communication channel, and the new message may trigger the patent-relevancy test. In some other examples, a user may tag a message as potentially patent relevant, and the tag may trigger the patent-relevancy test. The computing device 605 may determine the one or more messages for the patent-relevancy test. In some examples, the computing device 605 may select a single message for the test. In some other examples, the computing device 605 may select multiple messages for the test, such as a message and one or more replies to the message. In some cases, if a message of the one or more messages includes a file attachment, the contents of the file attachment may additionally be used for the test.

At 620, the computing device 605 may generate a set of features corresponding to the one or more messages (e.g., the messages selected for the patent-relevancy test) posted to a group-based communication channel (e.g., a channel or direct messaging conversation) of the group-based communication system. The set of features may include an indication of one or more users associated with the one or more messages, an indication of the group-based communication channel, an indication of a type of the group-based communication channel, an indication of a quantity of users corresponding to the group-based communication channel, an indication of a message length for at least one message of the one or more messages, an indication of a channel description for the group-based communication channel, an indication of whether a file is attached to at least one message of the one or more messages, an indication of a quantity of replies for at least one message of the one or more messages, or any combination thereof.

At 625, the computing device 605 may input the set of features into a machine learning model. The machine learning model may include at least an embedding function trained based on embeddings of patent applications (e.g., portions of patent application documents) into an embedding space. The embedding function may be further trained based on messages tagged as patent relevant from the group-based communication system (e.g., confirmed as patent relevant, tagged to indicate that a patent application corresponding to a message was filed), non-patent literature embeddings, or both. The machine learning model may be an example of an embedding model or may use an output of the embedding function to support further machine learning processes. Inputting the set of features into the machine learning model may involve embedding the one or more messages into the embedding space, for example, using the trained embedding function.

At 630, the computing device 605 may determine whether the one or more messages are associated with a patentable concept based on an output of the machine learning model. For example, the computing device 605 may receive, in response to inputting the set of features into the machine learning model, an output of the machine learning model indicating that the one or more messages are associated with a patentable concept. In some examples, the output may be based on a distance associated with an embedding of the one or more messages and multiple patent application embeddings within the embedding space satisfying a proximity threshold. For example, the embedding of the one or more messages may satisfy the proximity threshold if the embedding is within a region of the embedding space associated with patent applications, if a distance between the embedding and a centroid associated with the patent application embeddings fails to satisfy (e.g., is below) a first threshold distance, if a distance between the embedding and a patent application embedding (e.g., any patent application embedding) satisfies (e.g., is greater than) a second threshold distance, or any combination thereof. The embedding may be further based on text from one or more files attached to one or more of the messages.

At 635, the computing device 605 may send, to the user device 610 for display, the indication that the one or more messages are associated with the patentable concept. The user device 610 may be operated by a user associated with patent management (e.g., a patent professional with credentials to review patent ideas saved in the group-based communication platform). If the output of the machine learning model indicates that the one or more messages are unlikely to be associated with a patentable concept, the computing device 605 may refrain from sending any indication of the output to the user device 610. In some cases, the computing device 605 may send an indication that a patent-relevancy test was performed on the one or more messages.

In some examples, the computing device 605 may additionally send, to the user device 610 for display, an indication of one or more patent applications associated with the one or more messages based on the embedding space. Additionally, or alternatively, the computing device 605 may send, to the user device 610 for display, an indication of one or more suggested inventors associated with the one or more messages and the patentable concept based on the output of the machine learning model.

In some cases, at 640, the computing device 605 may receive, from the user device 610, user feedback. The user feedback may be in response to the indication that the one or more messages are associated with the patentable concept. In some such cases, at 645, the computing device 605 (or another device managing machine learning processes) may update the machine learning model based on the user feedback.

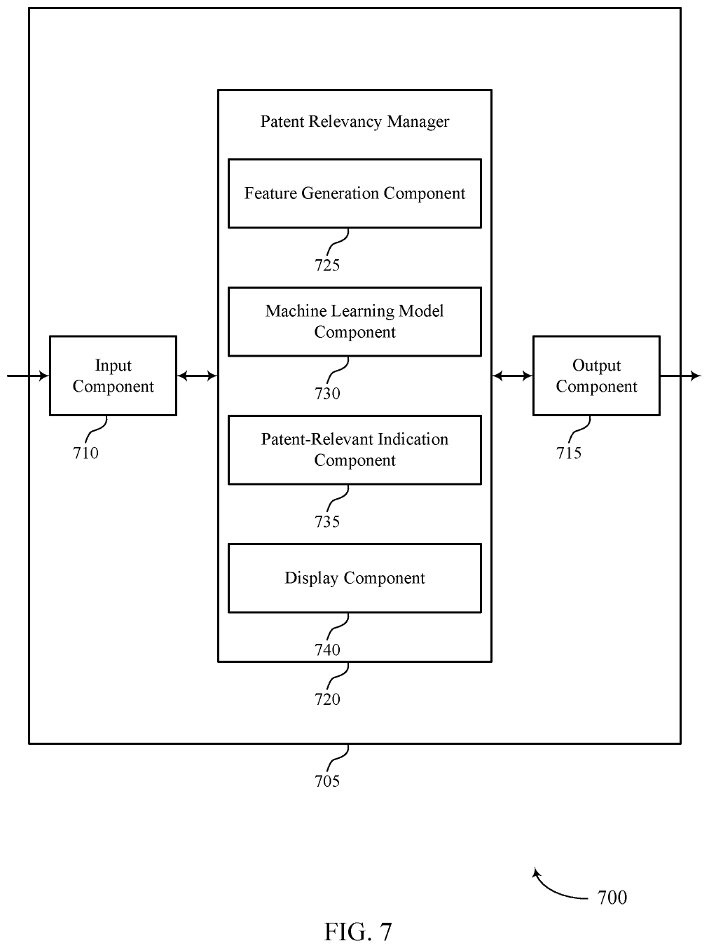

FIG. 7 illustrates a block diagram 700 of a device 705 that supports identification of patent-relevant messages in a group-based communication system using machine learning techniques in accordance with aspects of the present disclosure. The device 705 may include an input component 710, an output component 715, and a patent relevancy manager 720. The device 705 may also include a processor. Each of these components may be in communication with one another (e.g., via one or more buses).

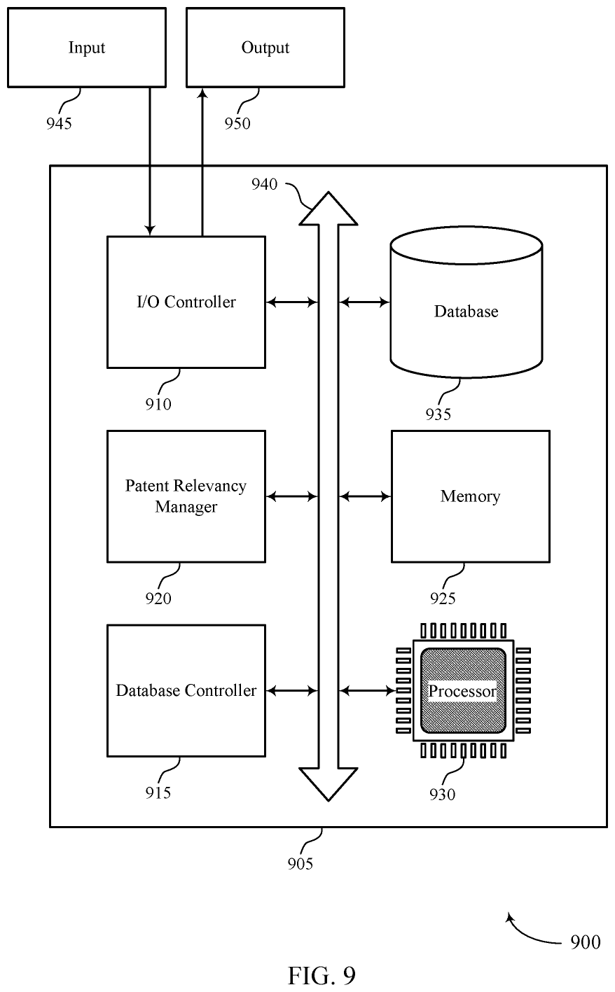

The input component 710 may manage input signals for the device 705. For example, the input component 710 may identify input signals based on an interaction with a modem, a keyboard, a mouse, a touchscreen, or a similar device. These input signals may be associated with user input or processing at other components or devices. In some cases, the input component 710 may utilize an operating system such as iOS®, ANDROID®, MS-DOS®, MS-WINDOWS®, OS/2®, UNIX®, LINUX®, or another known operating system to handle input signals. The input component 710 may send aspects of these input signals to other components of the device 705 for processing. For example, the input component 710 may transmit input signals to the patent relevancy manager 720 to support identification of patent-relevant messages in a group-based communication system using machine learning techniques. In some cases, the input component 710 may be a component of an input/output (I/O) controller 910 as described with reference to FIG. 9.

The output component 715 may manage output signals for the device 705. For example, the output component 715 may receive signals from other components of the device 705, such as the patent relevancy manager 720, and may transmit these signals to other components or devices. In some examples, the output component 715 may transmit output signals for display in a user interface, for storage in a database or data store, for further processing at a server or server cluster, or for any other processes at any number of devices or systems. In some cases, the output component 715 may be a component of an I/O controller 910 as described with reference to FIG. 9.

For example, the patent relevancy manager 720 may include a feature generation component 725, a machine learning model component 730, a patent-relevant indication component 735, a display component 740, or any combination thereof. In some examples, the patent relevancy manager 720, or various components thereof, may be configured to perform various operations (e.g., receiving, monitoring, transmitting) using or otherwise in cooperation with the input component 710, the output component 715, or both. For example, the patent relevancy manager 720 may receive information from the input component 710, send information to the output component 715, or be integrated in combination with the input component 710, the output component 715, or both to receive information, transmit information, or perform various other operations as described herein.

The patent relevancy manager 720 may support patent-relevant message identification in accordance with examples as disclosed herein. The feature generation component 725 may be configured to support generating a set of features corresponding to one or more messages posted to a group-based communication channel of a group-based communication system. The machine learning model component 730 may be configured to support inputting the set of features into a machine learning model, the machine learning model including at least an embedding function trained based on embeddings of portions of patent application documents into an embedding space. The patent-relevant indication component 735 may be configured to support receiving, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. The display component 740 may be configured to support sending, to a user device for display, the indication that the one or more messages are associated with the patentable concept.

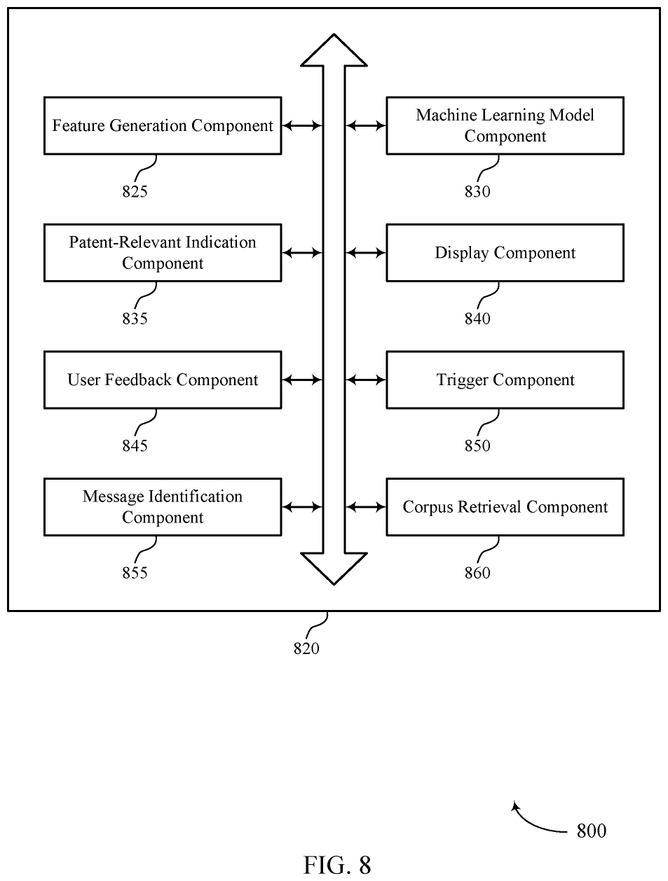

FIG. 8 illustrates a block diagram 800 of a patent relevancy manager 820 that supports identification of patent-relevant messages in a group-based communication system using machine learning techniques in accordance with aspects of the present disclosure. The patent relevancy manager 820 may be an example of aspects of a patent relevancy manager 720, as described herein. The patent relevancy manager 820, or various components thereof, may be an example of means for performing various aspects of identification of patent-relevant messages in a group-based communication system using machine learning techniques as described herein. For example, the patent relevancy manager 820 may include a feature generation component 825, a machine learning model component 830, a patent-relevant indication component 835, a display component 840, a user feedback component 845, a trigger component 850, a message identification component 855, a corpus retrieval component 860, or any combination thereof. Each of these components may communicate, directly or indirectly, with one another (e.g., via one or more buses).

The patent relevancy manager 820 may support patent-relevant message identification in accordance with examples as disclosed herein. The feature generation component 825 may be configured to support generating a set of features corresponding to one or more messages posted to a group-based communication channel of a group-based communication system. The machine learning model component 830 may be configured to support inputting the set of features into a machine learning model, the machine learning model including at least an embedding function trained based on embeddings of portions of patent application documents into an embedding space. The patent-relevant indication component 835 may be configured to support receiving, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. The display component 840 may be configured to support sending, to a user device for display, the indication that the one or more messages are associated with the patentable concept.

In some examples, the user feedback component 845 may be configured to support receiving, from the user device, user feedback in response to the indication that the one or more messages are associated with the patentable concept, where the machine learning model is updated based on the user feedback. In some examples, the user feedback includes a first indication of whether the one or more messages support a patent application, a second indication of whether the patent application is relevant to an organization, a third indication of a prior art concern for the patent application, a fourth indication of whether the one or more messages support a trade secret, or any combination thereof.

In some examples, to support sending the indication that the one or more messages are associated with the patentable concept, the display component 840 may be configured to support sending, to the user device for display, an indication of one or more patent applications associated with the one or more messages based on the embedding space. In some examples, to support sending the indication that the one or more messages are associated with the patentable concept, the display component 840 may be configured to support sending, to the user device for display, an indication of one or more suggested inventors associated with the one or more messages and the patentable concept based on the output of the machine learning model.

In some examples, the trigger component 850 may be configured to support receiving, from a second user device, a new message posted to the group-based communication channel, where the one or more messages includes the new message and the set of features is generated in response to the new message being posted to the group-based communication channel. In some other examples, the trigger component 850 may be configured to support receiving, from a second user device, a user input tagging a message as potentially patent relevant, where the one or more messages includes the message and the set of features is generated in response to the user input tagging the message as potentially patent relevant.

In some examples, the message identification component 855 may be configured to support identifying one or more additional messages that are associated with the patentable concept from one or more additional group-based communication channels different from the group-based communication channel. In some examples, to support sending the indication that the one or more messages are associated with the patentable concept, the display component 840 may be configured to support sending, to the user device for display, a second indication that the one or more additional messages are associated with the patentable concept.

In some examples, the corpus retrieval component 860 may be configured to support retrieving a corpus including at least the portions of the patent application documents, where the portions of the patent application documents include abstracts of the patent application documents, summaries of the patent application documents, detailed descriptions of the patent application documents, claims of the patent application documents, art units of the patent application documents, prosecution statuses of the patent application documents, or any combination thereof. In some examples, the corpus retrieval component 860 may be configured to support filtering the patent application documents from a set of multiple patent application documents based on a type of patent. In some examples, the output further indicates a type of patent associated with the one or more messages. In some examples, the machine learning model includes a first machine learning model associated with identifying first patentable concepts corresponding to a first type of patent. In some examples, a second machine learning model is associated with identifying second patentable concepts corresponding to a second type of patent different from the first type of patent.

In some examples, the distance associated with the embedding of the one or more messages and the set of multiple patent application embeddings within the embedding space satisfies the proximity threshold based on a first distance between the embedding of the one or more messages being less than a first threshold distance from a centroid associated with the set of multiple patent application embeddings and a second distance between the embedding of the one or more messages being greater than a second threshold distance from a patent application embedding (e.g., each patent application embedding) of the set of multiple patent application embeddings.

In some examples, the set of features includes a first indication of one or more users associated with the one or more messages, a second indication of the group-based communication channel, a third indication of a type of the group-based communication channel, a fourth indication of a quantity of users corresponding to the group-based communication channel, a fifth indication of a message length for at least one message of the one or more messages, a sixth indication of a channel description for the group-based communication channel, a seventh indication of whether a file is attached to at least one message of the one or more messages, an eight indication of a quantity of replies for at least one message of the one or more messages, or any combination thereof.

In some examples, the one or more messages include a first message posted to the group-based communication channel and one or more replies to the first message within the group-based communication channel. In some examples, the embedding of the one or more messages is based on text from a file corresponding to a message of the one or more messages.

In some examples, the embedding function is further trained based on a set of multiple messages tagged as patent relevant from the group-based communication system. In some examples, the embedding function is further trained based on additional embeddings of portions of non-patent literature into the embedding space.

FIG. 9 illustrates a diagram of a system 900 including a device 905 that supports identification of patent-relevant messages in a group-based communication system using machine learning techniques in accordance with aspects of the present disclosure. The device 905 may be an example of or include the components of a device 705 as described herein. The device 905 may be an example of a processing device, such as an application server, a database server, a cloud-based server or service, a worker server, a server cluster, a virtual machine, a container, a network device, a user device, or any combination of these or other computing devices. The device 905 may include components for bi-directional data communications including components for transmitting and receiving communications, such as a patent relevancy manager 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause the processor 930 to perform various functions described herein. In some cases, the memory 925 may contain, among other things, a basic I/O system (BIOS) which may control basic hardware or software operation such as the interaction with peripheral components or devices.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting identification of patent-relevant messages in a group-based communication system using machine learning techniques).

The patent relevancy manager 920 may support patent-relevant message identification in accordance with examples as disclosed herein. For example, the patent relevancy manager 920 may be configured to support generating a set of features corresponding to one or more messages posted to a group-based communication channel of a group-based communication system. The patent relevancy manager 920 may be configured to support inputting the set of features into a machine learning model, the machine learning model including at least an embedding function trained based on embeddings of portions of patent application documents into an embedding space. The patent relevancy manager 920 may be configured to support receiving, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. The patent relevancy manager 920 may be configured to support sending, to a user device for display, the indication that the one or more messages are associated with the patentable concept.

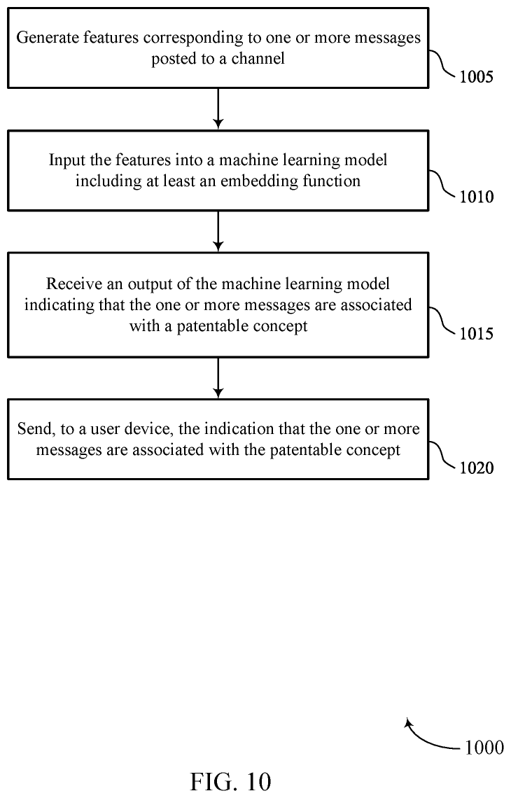

FIG. 10 illustrates a flowchart showing a method 1000 that supports identification of patent-relevant messages in a group-based communication system using machine learning techniques in accordance with aspects of the present disclosure. The operations of the method 1000 may be implemented by a group-based communication system or its components (e.g., a processing device, such as an application server, a database server, a cloud-based server or service, a worker server, a server cluster, a virtual machine, a container, a network device, a user device, or any combination of these or other computing devices) as described herein. For example, the operations of the method 1000 may be performed by a group-based communication system as described with reference to FIGS. 1 through 9. In some examples, a group-based communication system may execute a set of instructions to control the functional elements of the group-based communication system to perform the described functions. Additionally, or alternatively, the group-based communication system may perform aspects of the described functions using special-purpose hardware.

At 1005, the method may include generating a set of features corresponding to one or more messages posted to a group-based communication channel of a group-based communication system. The operations of 1005 may be performed in accordance with examples as disclosed herein. In some examples, aspects of the operations of 1005 may be performed by a feature generation component 825 as described with reference to FIG. 8.

At 1010, the method may include inputting the set of features into a machine learning model. The machine learning model may include at least an embedding function trained based on embeddings of portions of patent application documents into an embedding space. The operations of 1010 may be performed in accordance with examples as disclosed herein. In some examples, aspects of the operations of 1010 may be performed by a machine learning model component 830 as described with reference to FIG. 8.

At 1015, the method may include receiving, in response to the inputting the set of features into the machine learning model, an output of the machine learning model. The output may include an indication that the one or more messages are associated with a patentable concept. The output may be based on a distance associated with an embedding of the one or more messages and a set of multiple patent application embeddings within the embedding space satisfying a proximity threshold. The operations of 1015 may be performed in accordance with examples as disclosed herein. In some examples, aspects of the operations of 1015 may be performed by a patent-relevant indication component 835 as described with reference to FIG. 8.

At 1020, the method may include sending, to a user device for display, the indication that the one or more messages are associated with the patentable concept. The operations of 1020 may be performed in accordance with examples as disclosed herein. In some examples, aspects of the operations of 1020 may be performed by a display component 840 as described with reference to FIG. 8.

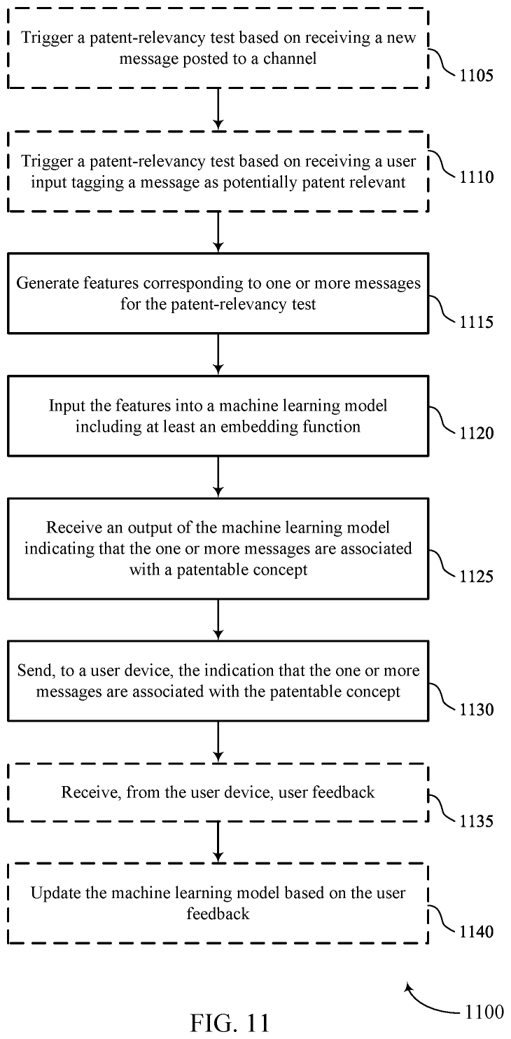

FIG. 11 illustrates a flowchart showing a method 1100 that supports identification of patent-relevant messages in a group-based communication system using machine learning techniques in accordance with aspects of the present disclosure. The operations of the method 1100 may be implemented by a group-based communication system or its components (e.g., a processing device, such as an application server, a database server, a cloud-based server or service, a worker server, a server cluster, a virtual machine, a container, a network device, a user device, or any combination of these or other computing devices) as described herein. For example, the operations of the method 1100 may be performed by a group-based communication system as described with reference to FIGS. 1 through 9. In some examples, a group-based communication system may execute a set of instructions to control the functional elements of the group-based communication system to perform the described functions. Additionally, or alternatively, the group-based communication system may perform aspects of the described functions using special-purpose hardware.

In some examples, at 1105, the method may include receiving, from a user device, a new message posted to a group-based communication channel. The new message may trigger a patent-relevancy test for one or more messages including at least the new message. The operations of 1105 may be performed in accordance with examples as disclosed herein. In some examples, aspects of the operations of 1105 may be performed by a trigger component 850 as described with reference to FIG. 8.

In some other examples, at 1110, the method may include receiving, from a user device, a user input tagging a message as potentially patent relevant. The tag may trigger a patent-relevancy test for one or more messages including at least the message tagged as potentially patent relevant. The operations of 1110 may be performed in accordance with examples as disclosed herein. In some examples, aspects of the operations of 1110 may be performed by a trigger component 850 as described with reference to FIG. 8.

At 1115, the method may include generating a set of features corresponding to the one or more messages posted to the group-based communication channel of a group-based communication system. The set of features may be generated for the triggered patent-relevancy test. The operations of 1115 may be performed in accordance with examples as disclosed herein. In some examples, aspects of the operations of 1115 may be performed by a feature generation component 825 as described with reference to FIG. 8.

At 1120, the method may include inputting the set of features into a machine learning model as part of the patent-relevancy test. The machine learning model may include at least an embedding function trained based on embeddings of portions of patent application documents into an embedding space. The operations of 1120 may be performed in accordance with examples as disclosed herein. In some examples, aspects of the operations of 1120 may be performed by a machine learning model component 830 as described with reference to FIG. 8.

At 1125, the method may include receiving, in response to the inputting the set of features into the machine learning model, an output of the machine learning model, the output including an indication that the one or more messages are associated with a patentable concept. The output may be based on a distance associated with an embedding of the one or more messages and a set of multiple patent application embeddings within the embedding space satisfying a proximity threshold. The operations of 1125 may be performed in accordance with examples as disclosed herein. In some examples, aspects of the operations of 1125 may be performed by a patent-relevant indication component 835 as described with reference to FIG. 8.

At 1130, the method may include sending, to a user device for display, the indication that the one or more messages are associated with the patentable concept. The operations of 1130 may be performed in accordance with examples as disclosed herein. In some examples, aspects of the operations of 1130 may be performed by a display component 840 as described with reference to FIG. 8.

In some examples, at 1135, the method may include receiving, from the user device, user feedback in response to the indication that the one or more messages are associated with the patentable concept. The user feedback may confirm or deny whether the one or more messages are associated with the patentable concept. In some cases, the user feedback may indicate whether the patentable concept is valuable to an organization. The operations of 1135 may be performed in accordance with examples as disclosed herein. In some examples, aspects of the operations of 1135 may be performed by a user feedback component 845 as described with reference to FIG. 8.

In some examples, at 1140, the method may include updating the machine learning model based on the user feedback. For example, the group-based communication system or another system may further train the machine learning model based on the user feedback. The operations of 1140 may be performed in accordance with examples as disclosed herein. In some examples, aspects of the operations of 1140 may be performed by a user feedback component 845 as described with reference to FIG. 8.

A method for patent-relevant message identification is described. The method may include generating a set of features corresponding to one or more messages posted to a group-based communication channel of a group-based communication system and inputting the set of features into a machine learning model, the machine learning model including at least an embedding function trained based on embeddings of portions of patent application documents into an embedding space. The method may further include receiving, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. Additionally, the method may include sending, to a user device for display, the indication that the one or more messages are associated with the patentable concept.

An apparatus for patent-relevant message identification is described. The apparatus may include a processor, memory coupled with the processor, and instructions stored in the memory. The instructions may be executable by the processor to cause the apparatus to generate a set of features corresponding to one or more messages posted to a group-based communication channel of a group-based communication system and input the set of features into a machine learning model, the machine learning model including at least an embedding function trained based on embeddings of portions of patent application documents into an embedding space. The instructions may be further executable by the processor to cause the apparatus to receive, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. Additionally, the instructions may be executable by the processor to cause the apparatus to send, to a user device for display, the indication that the one or more messages are associated with the patentable concept.

Another apparatus for patent-relevant message identification is described. The apparatus may include means for generating a set of features corresponding to one or more messages posted to a group-based communication channel of a group-based communication system and means for inputting the set of features into a machine learning model, the machine learning model including at least an embedding function trained based on embeddings of portions of patent application documents into an embedding space. The apparatus may further include means for receiving, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. Additionally, the apparatus may include means for sending, to a user device for display, the indication that the one or more messages are associated with the patentable concept.

A non-transitory computer-readable medium storing code for patent-relevant message identification is described. The code may include instructions executable by a processor to generate a set of features corresponding to one or more messages posted to a group-based communication channel of a group-based communication system and input the set of features into a machine learning model, the machine learning model including at least an embedding function trained based on embeddings of portions of patent application documents into an embedding space. The code may further include instructions executable by a processor to receive, in response to the inputting the set of features into the machine learning model, an output of the machine learning model, the output including an indication that the one or more messages are associated with a patentable concept, where the output is based on a distance associated with an embedding of the one or more messages and a set of multiple patent application embeddings within the embedding space satisfying a proximity threshold. Additionally, the code may include instructions executable by a processor to send, to a user device for display, the indication that the one or more messages are associated with the patentable concept.

Some examples of the method, apparatuses, and non-transitory computer-readable medium described herein may further include operations, features, means, or instructions for receiving, from the user device, user feedback in response to the indication that the one or more messages are associated with the patentable concept, where the machine learning model may be updated based on the user feedback.

In some examples of the method, apparatuses, and non-transitory computer-readable medium described herein, the user feedback includes a first indication of whether the one or more messages support a patent application, a second indication of whether the patent application is relevant to an organization, a third indication of a prior art concern for the patent application, a fourth indication of whether the one or more messages support a trade secret, or any combination thereof.

In some examples of the method, apparatuses, and non-transitory computer-readable medium described herein, sending the indication that the one or more messages are associated with the patentable concept may include operations, features, means, or instructions for sending, to the user device for display, an indication of one or more patent applications associated with the one or more messages based on the embedding space.

In some examples of the method, apparatuses, and non-transitory computer-readable medium described herein, sending the indication that the one or more messages are associated with the patentable concept may include operations, features, means, or instructions for sending, to the user device for display, an indication of one or more suggested inventors associated with the one or more messages and the patentable concept based on the output of the machine learning model.

Some examples of the method, apparatuses, and non-transitory computer-readable medium described herein may further include operations, features, means, or instructions for receiving, from a second user device, a new message posted to the group-based communication channel, where the one or more messages include the new message, and the set of features is generated in response to the new message being posted to the group-based communication channel.

Some examples of the method, apparatuses, and non-transitory computer-readable medium described herein may further include operations, features, means, or instructions for receiving, from a second user device, a user input tagging a message as potentially patent relevant, where the one or more messages include the message, and the set of features is generated in response to the user input tagging the message as potentially patent relevant.

Some examples of the method, apparatuses, and non-transitory computer-readable medium described herein may further include operations, features, means, or instructions for identifying one or more additional messages that are associated with the patentable concept from one or more additional group-based communication channels different from the group-based communication channel. In some examples of the method, apparatuses, and non-transitory computer-readable medium described herein, sending the indication that the one or more messages are associated with the patentable concept may include operations, features, means, or instructions for sending, to the user device for display, a second indication that the one or more additional messages are associated with the patentable concept.

Some examples of the method, apparatuses, and non-transitory computer-readable medium described herein may further include operations, features, means, or instructions for retrieving a corpus including at least the portions of the patent application documents, where the portions of the patent application documents include abstracts of the patent application documents, summaries of the patent application documents, detailed descriptions of the patent application documents, claims of the patent application documents, art units of the patent application documents, prosecution statuses of the patent application documents, or any combination thereof. Some examples of the method, apparatuses, and non-transitory computer-readable medium described herein may further include operations, features, means, or instructions for filtering the patent application documents from a set of multiple patent application documents based on a type of patent.

In some examples of the method, apparatuses, and non-transitory computer-readable medium described herein, the output further indicates a type of patent associated with the one or more messages. In some examples of the method, apparatuses, and non-transitory computer-readable medium described herein, the machine learning model includes a first machine learning model associated with identifying first patentable concepts corresponding to a first type of patent, and a second machine learning model may be associated with identifying second patentable concepts corresponding to a second type of patent different from the first type of patent.

In some examples of the method, apparatuses, and non-transitory computer-readable medium described herein, the distance associated with the embedding of the one or more messages and the set of multiple patent application embeddings within the embedding space satisfies the proximity threshold based on a first distance between the embedding of the one or more messages being less than a first threshold distance from a centroid associated with the set of multiple patent application embeddings and a second distance between the embedding of the one or more messages being greater than a second threshold distance from a patent application embedding of the set of multiple patent application embeddings.

In some examples of the method, apparatuses, and non-transitory computer-readable medium described herein, the set of features includes a first indication of one or more users associated with the one or more messages, a second indication of the group-based communication channel, a third indication of a type of the group-based communication channel, a fourth indication of a quantity of users corresponding to the group-based communication channel, a fifth indication of a message length for at least one message of the one or more messages, a sixth indication of a channel description for the group-based communication channel, a seventh indication of whether a file is attached to at least one message of the one or more messages, an eight indication of a quantity of replies for at least one message of the one or more messages, or any combination thereof.

In some examples of the method, apparatuses, and non-transitory computer-readable medium described herein, the one or more messages include a first message posted to the group-based communication channel and one or more replies to the first message within the group-based communication channel. In some examples of the method, apparatuses, and non-transitory computer-readable medium described herein, the embedding of the one or more messages may be based on text from a file corresponding to a message of the one or more messages.

In some examples of the method, apparatuses, and non-transitory computer-readable medium described herein, the embedding function may be further trained based on a set of multiple messages tagged as patent relevant from the group-based communication system. In some examples of the method, apparatuses, and non-transitory computer-readable medium described herein, the embedding function may be further trained based on additional embeddings of portions of non-patent literature into the embedding space.

The following provides an overview of aspects of the present disclosure:
Aspect 1: A method for patent-relevant message identification, comprising: generating a set of features corresponding to one or more messages posted to a group-based communication channel of a group-based communication system: inputting the set of features into a machine learning model, the machine learning model comprising at least an embedding function trained based at least in part on embeddings of portions of patent application documents into an embedding space: receiving, in response to the inputting the set of features into the machine learning model, an output of the machine learning model, the output comprising an indication that the one or more messages are associated with a patentable concept, wherein the output is based at least in part on a distance associated with an embedding of the one or more messages and a plurality of patent application embeddings within the embedding space satisfying a proximity threshold; and sending, to a user device for display, the indication that the one or more messages are associated with the patentable concept.
Aspect 2: The method of aspect 1, further comprising: receiving, from the user device, user feedback in response to the indication that the one or more messages are associated with the patentable concept, wherein the machine learning model is updated based at least in part on the user feedback.
Aspect 3: The method of aspect 2, wherein the user feedback comprises a first indication of whether the one or more messages support a patent application, a second indication of whether the patent application is relevant to an organization, a third indication of a prior art concern for the patent application, a fourth indication of whether the one or more messages support a trade secret, or any combination thereof.
Aspect 4: The method of any of aspects 1 through 3, wherein sending the indication that the one or more messages are associated with the patentable concept further comprises: sending, to the user device for display, an indication of one or more patent applications associated with the one or more messages based at least in part on the embedding space.
Aspect 5: The method of any of aspects 1 through 4, wherein sending the indication that the one or more messages are associated with the patentable concept further comprises: sending, to the user device for display, an indication of one or more suggested inventors associated with the one or more messages and the patentable concept based at least in part on the output of the machine learning model.
Aspect 6: The method of any of aspects 1 through 5, further comprising: receiving, from a second user device, a new message posted to the group-based communication channel, wherein the one or more messages comprises the new message and the set of features is generated in response to the new message being posted to the group-based communication channel.
Aspect 7: The method of any of aspects 1 through 5, further comprising: receiving, from a second user device, a user input tagging a message as potentially patent relevant, wherein the one or more messages comprises the message and the set of features is generated in response to the user input tagging the message as potentially patent relevant.
Aspect 8: The method of any of aspects 1 through 7, further comprising: identifying one or more additional messages that are associated with the patentable concept from one or more additional group-based communication channels different from the group-based communication channel, wherein sending the indication that the one or more messages are associated with the patentable concept further comprises: sending, to the user device for display, a second indication that the one or more additional messages are associated with the patentable concept.
Aspect 9: The method of any of aspects 1 through 8, further comprising: retrieving a corpus comprising at least the portions of the patent application documents, wherein the portions of the patent application documents comprise abstracts of the patent application documents, summaries of the patent application documents, detailed descriptions of the patent application documents, claims of the patent application documents, art units of the patent application documents, prosecution statuses of the patent application documents, or any combination thereof.
Aspect 10: The method of aspect 9, further comprising: filtering the patent application documents from a plurality of patent application documents based at least in part on a type of patent.
Aspect 11: The method of any of aspects 1 through 10, wherein the output further indicates a type of patent associated with the one or more messages.
Aspect 12: The method of any of aspects 1 through 10, wherein the machine learning model comprises a first machine learning model associated with identifying first patentable concepts corresponding to a first type of patent; and a second machine learning model is associated with identifying second patentable concepts corresponding to a second type of patent different from the first type of patent.
Aspect 13: The method of any of aspects 1 through 12, wherein the distance associated with the embedding of the one or more messages and the plurality of patent application embeddings within the embedding space satisfies the proximity threshold based at least in part on a first distance between the embedding of the one or more messages being less than a first threshold distance from a centroid associated with the plurality of patent application embeddings and a second distance between the embedding of the one or more messages being greater than a second threshold distance from a patent application embedding of the plurality of patent application embeddings.
Aspect 14: The method of any of aspects 1 through 13, wherein the set of features comprises a first indication of one or more users associated with the one or more messages, a second indication of the group-based communication channel, a third indication of a type of the group-based communication channel, a fourth indication of a quantity of users corresponding to the group-based communication channel, a fifth indication of a message length for at least one message of the one or more messages, a sixth indication of a channel description for the group-based communication channel, a seventh indication of whether a file is attached to at least one message of the one or more messages, an eight indication of a quantity of replies for at least one message of the one or more messages, or any combination thereof.
Aspect 15: The method of any of aspects 1 through 14, wherein the one or more messages comprise a first message posted to the group-based communication channel and one or more replies to the first message within the group-based communication channel.
Aspect 16: The method of any of aspects 1 through 15, wherein the embedding of the one or more messages is based at least in part on text from a file corresponding to a message of the one or more messages.
Aspect 17: The method of any of aspects 1 through 16, wherein the embedding function is further trained based at least in part on a plurality of messages tagged as patent relevant from the group-based communication system.
Aspect 18: The method of any of aspects 1 through 17, wherein the embedding function is further trained based at least in part on additional embeddings of portions of non-patent literature into the embedding space.
Aspect 19: An apparatus for patent-relevant message identification, comprising a processor: memory coupled with the processor; and instructions stored in the memory and executable by the processor to cause the apparatus to perform a method of any of aspects 1 through 18.
Aspect 20: An apparatus for patent-relevant message identification, comprising at least one means for performing a method of any of aspects 1 through 18.
Aspect 21: A non-transitory computer-readable medium storing code for patent-relevant message identification, the code comprising instructions executable by a processor to perform a method of any of aspects 1 through 18.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for patent-relevant message identification, comprising:
generating a set of features corresponding to one or more messages posted to a group-based communication channel of a group-based communication system;
inputting the set of features into a machine learning model, the machine learning model comprising at least an embedding function trained based at least in part on embeddings of portions of patent application documents into an embedding space;
receiving, in response to the inputting the set of features into the machine learning model, an output of the machine learning model, the output comprising an indication that the one or more messages are associated with a patentable concept, wherein the output is based at least in part on a distance associated with an embedding of the one or more messages and a plurality of patent application embeddings within the embedding space satisfying a proximity threshold; and
sending, to a user device for display, the indication that the one or more messages are associated with the patentable concept.

2. The method of claim 1, further comprising:
receiving, from the user device, user feedback in response to the indication that the one or more messages are associated with the patentable concept, wherein the machine learning model is updated based at least in part on the user feedback.

3. The method of claim 2, wherein the user feedback comprises a first indication of whether the one or more messages support a patent application, a second indication of whether the patent application is relevant to an organization, a third indication of a prior art concern for the patent application, a fourth indication of whether the one or more messages support a trade secret, or any combination thereof.

4. The method of claim 1, wherein sending the indication that the one or more messages are associated with the patentable concept further comprises:
sending, to the user device for display, an indication of one or more patent applications associated with the one or more messages based at least in part on the embedding space.

5. The method of claim 1, wherein sending the indication that the one or more messages are associated with the patentable concept further comprises:
sending, to the user device for display, an indication of one or more suggested inventors associated with the one or more messages and the patentable concept based at least in part on the output of the machine learning model.

6. The method of claim 1, further comprising:
receiving, from a second user device, a new message posted to the group-based communication channel, wherein the one or more messages comprises the new message and the set of features is generated in response to the new message being posted to the group-based communication channel.

7. The method of claim 1, further comprising:
receiving, from a second user device, a user input tagging a message as potentially patent relevant, wherein the one or more messages comprises the message and the set of features is generated in response to the user input tagging the message as potentially patent relevant.

8. The method of claim 1, further comprising:
identifying one or more additional messages that are associated with the patentable concept from one or more additional group-based communication channels different from the group-based communication channel, wherein sending the indication that the one or more messages are associated with the patentable concept further comprises:
sending, to the user device for display, a second indication that the one or more additional messages are associated with the patentable concept.

9. The method of claim 1, further comprising:
retrieving a corpus comprising at least the portions of the patent application documents, wherein the portions of the patent application documents comprise abstracts of the patent application documents, summaries of the patent application documents, detailed descriptions of the patent application documents, claims of the patent application documents, art units of the patent application documents, prosecution statuses of the patent application documents, or any combination thereof.

10. The method of claim 9, further comprising:
filtering the patent application documents from a plurality of patent application documents based at least in part on a type of patent.

11. The method of claim 1, wherein the output further indicates a type of patent associated with the one or more messages.

12. The method of claim 1, wherein:
the machine learning model comprises a first machine learning model associated with identifying first patentable concepts corresponding to a first type of patent; and
a second machine learning model is associated with identifying second patentable concepts corresponding to a second type of patent different from the first type of patent.

13. The method of claim 1, wherein the distance associated with the embedding of the one or more messages and the plurality of patent application embeddings within the embedding space satisfies the proximity threshold based at least in part on a first distance between the embedding of the one or more messages being less than a first threshold distance from a centroid associated with the plurality of patent application embeddings and a second distance between the embedding of the one or more messages being greater than a second threshold distance from a patent application embedding of the plurality of patent application embeddings.

14. The method of claim 1, wherein the set of features comprises a first indication of one or more users associated with the one or more messages, a second indication of the group-based communication channel, a third indication of a type of the group-based communication channel, a fourth indication of a quantity of users corresponding to the group-based communication channel, a fifth indication of a message length for at least one message of the one or more messages, a sixth indication of a channel description for the group-based communication channel, a seventh indication of whether a file is attached to at least one message of the one or more messages, an eight indication of a quantity of replies for at least one message of the one or more messages, or any combination thereof.

15. The method of claim 1, wherein the one or more messages comprise a first message posted to the group-based communication channel and one or more replies to the first message within the group-based communication channel.

16. The method of claim 1, wherein the embedding of the one or more messages is based at least in part on text from a file corresponding to a message of the one or more messages.

17. The method of claim 1, wherein the embedding function is further trained based at least in part on a plurality of messages tagged as patent relevant from the group-based communication system.

18. The method of claim 1, wherein the embedding function is further trained based at least in part on additional embeddings of portions of non-patent literature into the embedding space.

19. An apparatus for patent-relevant message identification, comprising:
a processor;
memory coupled with the processor; and
instructions stored in the memory and executable by the processor to cause the apparatus to:
generate a set of features corresponding to one or more messages posted to a group-based communication channel of a group-based communication system;
input the set of features into a machine learning model, the machine learning model comprising at least an embedding function trained based at least in part on embeddings of portions of patent application documents into an embedding space;
receive, in response to the inputting the set of features into the machine learning model, an output of the machine learning model, the output comprising an indication that the one or more messages are associated with a patentable concept, wherein the output is based at least in part on a distance associated with an embedding of the one or more messages and a plurality of patent application embeddings within the embedding space satisfying a proximity threshold; and
send, to a user device for display, the indication that the one or more messages are associated with the patentable concept.

20. A non-transitory computer-readable medium storing code for patent-relevant message identification, the code comprising instructions executable by a processor to:
generate a set of features corresponding to one or more messages posted to a group-based communication channel of a group-based communication system;
input the set of features into a machine learning model, the machine learning model comprising at least an embedding function trained based at least in part on embeddings of portions of patent application documents into an embedding space;
receive, in response to the inputting the set of features into the machine learning model, an output of the machine learning model, the output comprising an indication that the one or more messages are associated with a patentable concept, wherein the output is based at least in part on a distance associated with an embedding of the one or more messages and a plurality of patent application embeddings within the embedding space satisfying a proximity threshold; and
send, to a user device for display, the indication that the one or more messages are associated with the patentable concept.
